(19) United States
(12) Patent Application Publication
(10) Pub. No.: US 2011/0116473 A1
(43) Pub. Date: May 19, 2011

(54) METHOD AND APPARATUS FOR INTER-DEVICE HANDOVER (HO) BETWEEN INTERNET PROTOCOL (IP) MULTIMEDIA SUBSYSTEM (IMS) AND CIRCUIT SWITCHED (CS) WIRELESS TRANSMIT/RECEIVE UNITS (WTRUs)

(75) Inventors: Kamel M. Shaheen, King of Prussia, PA (US); Xavier De Foy, Kirkland (CA); Debashish Purkayastha, Pottstown, PA (US)

(73) Assignee: INTERDIGITAL PATENT HOLDINGS, INC., Wilmington, DE (US)

(21) Appl. No.: 12/943,152

(22) Filed: Nov. 10, 2010

Related U.S. Application Data
(60) Provisional application No. 61/259,958, filed on Nov. 10, 2009.
(60) Provisional application No. 61/264,510, filed on Nov. 25, 2009.
(60) Provisional application No. 61/288,165, filed on Dec. 18, 2009.

(51) Int. Cl. H04W 36/00

(52) U.S. Cl. 370/331

(57) ABSTRACT

A method and apparatus for Inter-User Equipment Transfer (IUT) of an IP Multimedia (IM) Subsystem (IMS) session between a circuit switched (CS) wireless transmit/receive unit (WTRU) and an IMS-capable WTRU.

### CROSS REFERENCE TO RELATED APPLICATIONS

This application claims the benefit of U.S. Provisional Application Ser. No. 61/259,958 filed on Nov. 10, 2009, U.S. Provisional Application Ser. No. 61/264,510 filed on Nov. 25, 2009 and U.S. Provisional Application Ser. No. 61/288,165 filed on Dec. 18, 2009, the contents of which are hereby incorporated by reference herein.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunication System (UMTS) Terrestrial Radio Access Network (UTRAN), Long Term Evolution (LTE), Worldwide Interoperability for Microwave Access (WiMax), or Wireless Local Area Network (WLAN) technology. A WTRU may access the IMS through a packet-switched (PS) domain. Through the use of IMS Centralized Services (ICS), a WTRU may additionally access IMS services via a circuit-switched (CS) domain. One feature available according to the IMS is the transfer of IMS sessions between multiple IMS-capable WTRUs. Accordingly, it would be advantageous for Inter-User Equipment Transfer (IUT) between an IMS-capable WTRU and a CS WTRU.

### SUMMARY

A method and apparatus for Inter-User Equipment Transfer (IUT) of an IP Multimedia (IM) Subsystem (IMS) session between a circuit switched (CS) wireless transmit/receive unit (WTRU) and an IMS-capable WTRU.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of an example of a Internet Protocol (IP) Multimedia Subsystem;

FIG. 3 shows an embodiment of a communication session using third party call control;

FIG. 4 shows an embodiment of a communication session using first party call control;

FIG. 5 shows an embodiment of a communication session using third party call control;

FIG. 6 shows an embodiment of a communication session using first party call control;

FIG. 7 shows an example of a transfer of session information from a PS domain to a CS domain;

FIG. 8A shows an example of architecture prior to HO of an IMS session from an IMS-capable WTRU to a CS WTRU;

FIG. 8B shows an example of architecture after HO of an IMS session from an IMS-capable WTRU to a CS WTRU;

FIG. 9A shows an example of IUT of an IMS session from an IMS-capable WTRU to a CS WTRU, where the SCC AS is used as an anchor to initiate a Remote Party update;

FIG. 9B is a continuation of FIG. 9A;

FIG. 10A shows an example of IUT of an IMS session from a CS WTRU to an IMS-capable WTRU, where the SCC AS is used as an anchor to initiate a Remote Party update;

FIG. 10B is a continuation of FIG. 10A;

FIG. 11 shows an example of IUT of an IMS session from one IMS-capable WTRU (controller) to another IMS-capable WTRU (controlee) in the same operator domain, where the SCC AS is used as an anchor to initiate a Remote Party update;

FIG. 12A shows an example of how signaling and bearer paths are combined and anchored at the SCC AS when the Service Control Signaling Path is established using an l1 reference point over a CS network before IUT;

FIG. 12B shows an example of how signaling and bearer paths are combined and anchored at the SCC AS when the Service Control Signaling Path is established using an Gm reference point over a PS network before IUT;

FIG. 12C shows an example of how signaling and bearer paths are combined and anchored at the SCC AS for sessions with PS media before IUT;

FIG. 13 is a high level diagram of IUT of IMS sessions between two or more operator domains;

FIG. 14 shows a detailed diagram for IUT of IMS sessions between two or more operator domains;

FIG. 15A shows an example of IUT of an IMS session from a CS WTRU in a CS operator domain, “A,” to an IMS-capable WTRU in a PS operator domain “B,” where the SCC AS (A) in the CS operator domain A, is used as an anchor to initiate the session transfer to operator domain B;

FIG. 15B is a continuation of FIG. 15A;

FIG. 16A shows an example of IUT of an IMS session from a CS WTRU in a CS operator domain, “A,” to an IMS-capable WTRU in a PS operator domain “B,” where the SCC AS (B) in the PS operator domain B is used as an anchor for session transfer from operator domain A;

FIG. 16B is a continuation of FIG. 16A;

FIG. 17 shows an example of a media flow release within a collaborative IMS session between a IMS-capable WTRU and a CS WTRU, where the SCC AS is an anchor for the session release initiated by the IMS-capable WTRU, controller, on the CS WTRU, controlee;

FIG. 18 shows an example of a media flow release within a collaborative IMS session between a IMS-capable WTRU and a CS WTRU, where the SCC AS is an anchor for the session release initiated by the IMS-capable WTRU, controller, on itself;

FIG. 19 shows an example of a media flow release within a collaborative IMS session between a IMS-capable WTRU and a CS WTRU, where the SCC AS is an anchor for the session release initiated by the CS WTRU, controlee, on the IMS-capable WTRU, controller;

FIG. 20 shows an example of a media flow release within a collaborative IMS session between a IMS-capable WTRU and a CS WTRU, where the SCC AS is an anchor for the session release initiated by the CS WTRU, controlee, on itself;

FIG. 21 shows an example of a media flow release within a collaborative IMS session between a IMS-capable WTRU and a CS WTRU, where the SCC AS is an anchor for the session release initiated by the IMS-capable WTRU, controlee, on the CS WTRU, controller;

FIG. 22 shows an example of a media flow release within a collaborative IMS session between a IMS-capable WTRU and a CS WTRU, where the SCC AS is an anchor for the session release initiated by the IMS-capable WTRU, controlee, on itself;

FIG. 23 shows an example of a media flow release within a collaborative IMS session between a IMS-capable WTRU and a CS WTRU, where the SCC AS is an anchor for the session release initiated by the CS WTRU, controller, on the IMS-capable WTRU, controlee; and

FIG. 24 shows an example of a media flow release within a collaborative IMS session between a IMS-capable WTRU and a CS WTRU, where the SCC AS is an anchor for the session release initiated by the CS WTRU, controlee, on itself.

### DETAILED DESCRIPTION

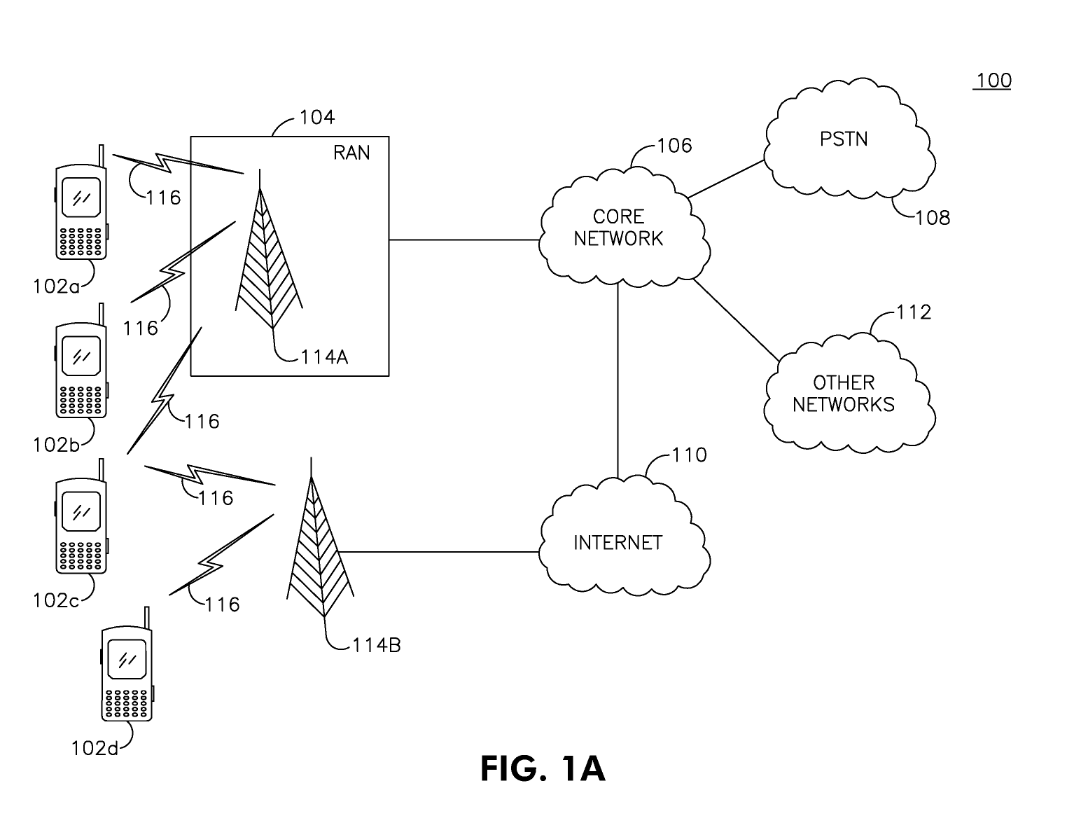

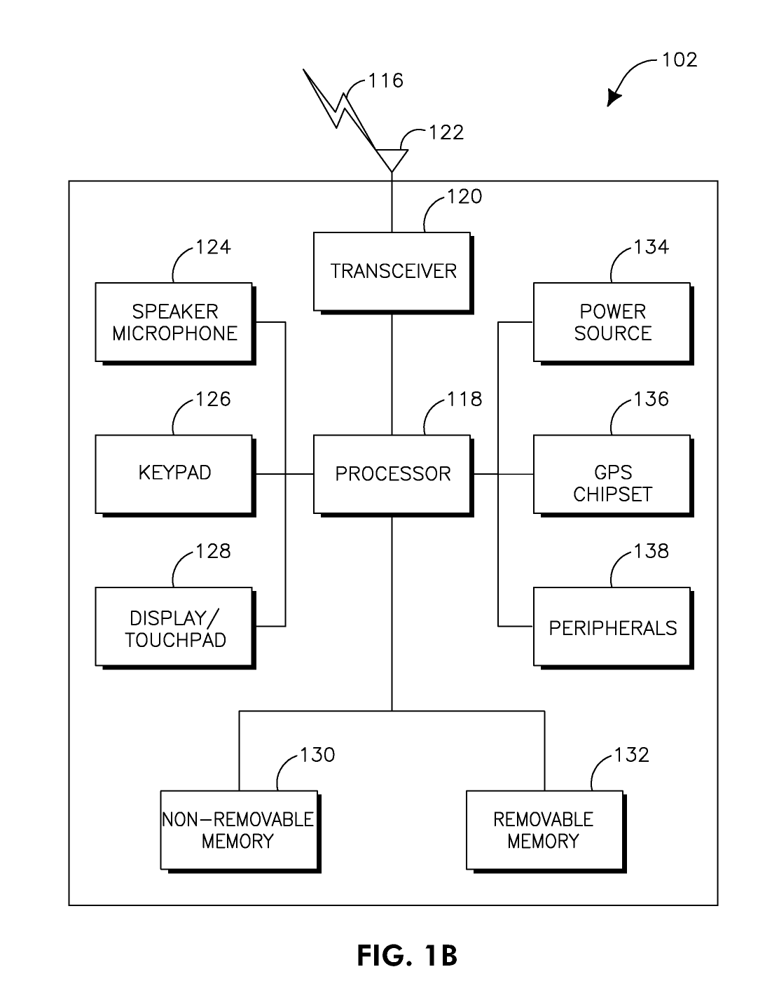

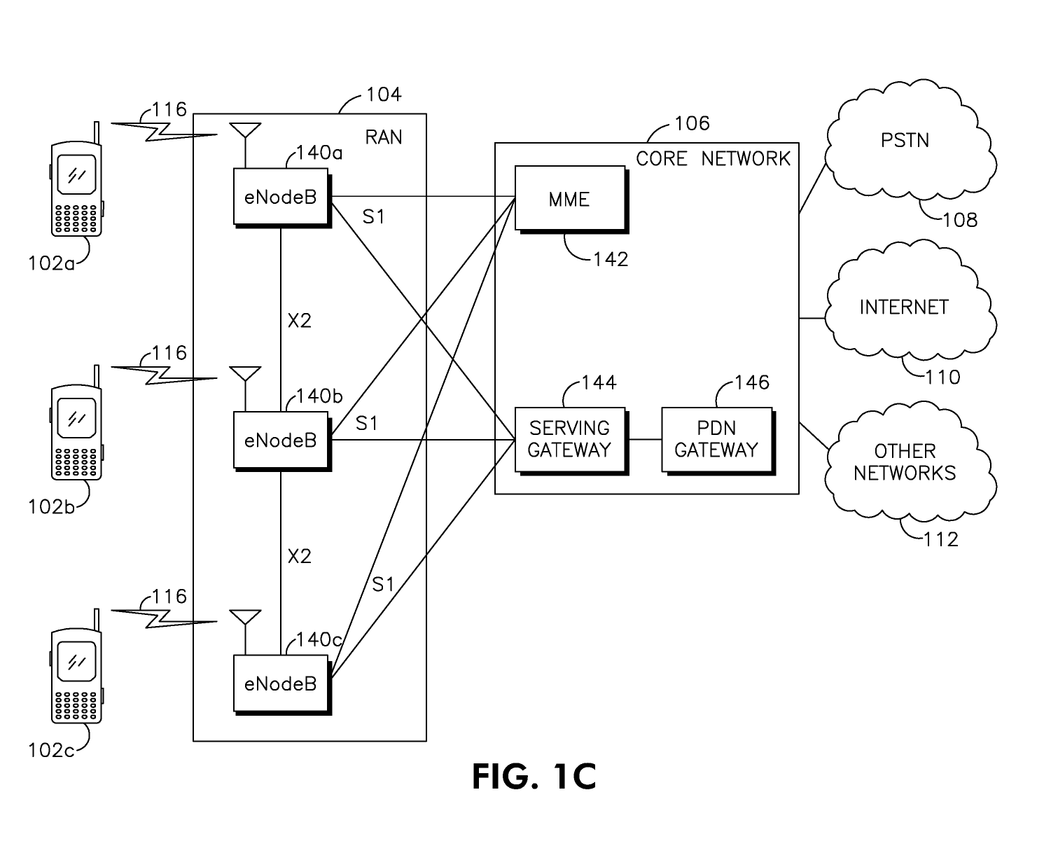

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

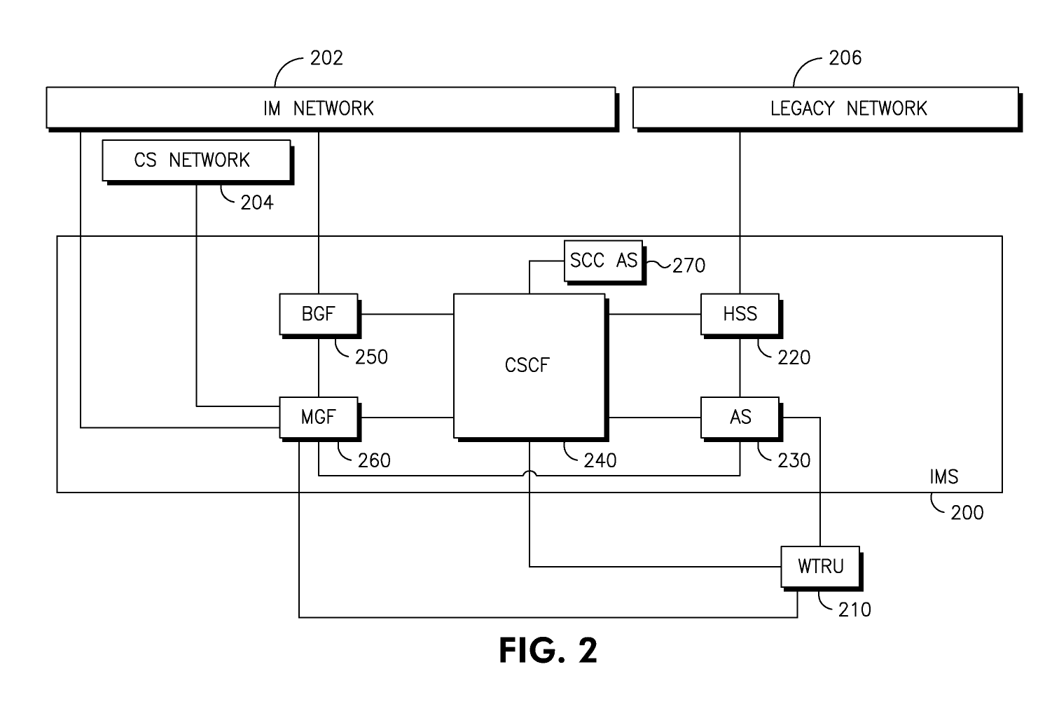

FIG. 2 is a diagram of an example of a Internet Protocol (IP) IP multimedia core network (IM CN), including an IP Multimedia (IM) Subsystem (IMS) 200, an IM network 202, a Circuit Switched (CS) network 204, a legacy network 206, in communication with a wireless transmit/receive unit (WTRU) 210. The IMS 200 includes core network (CN) elements for provision of IM services, such as audio, video, text, chat, or a combination thereof, delivered over the packet switched domain. As shown, the IMS 200 includes a Home Subscriber Server (HSS) 220, an Application Server (AS) 230, a Call Session Control Function (CSCF) 240, a Breakout Gateway Function (BGF) 250, a Media Gateway Function (MGF) 260, and a Service Centralization and Continuity Application Server (SCC AS) 270. In addition to the logical entities and signal paths shown in FIG. 2, an IMS may include any other configuration of logical entities which may be located in one or more physical devices. Although not shown in this logical example, the WTRU may be a separate physical unit and may be connected to the IM CN via a base station such as, a Node-B or an enhanced-NodeB (eNB).

The WTRU 210 may be any type of device configured to operate and/or communicate in a wired and/or wireless environment.

The HSS 220 may maintain and provide subscription-related information to support the network entities handling IM sessions. For example, the HSS may include identification information, security information, location information, and profile information for IMS users.

The AS 230, which may be a SIP Application Server, an OSA Application Server, or a CAMEL IM-SSF, may provide value added IM services and may reside in a home network or in a third party location. The AS may be included in a network, such as a home network, a core network, or a standalone AS network. The AS may provide IM services. For example, the AS may perform the functions of a terminating user agent (UA), a redirect server, an originating UA, a SIP proxy, or a third party call control.

The CSCF 240 may include a Proxy CSCF (P-CSCF), a Serving CSCF (S-CSCF), an Emergency CSCF (E-CSCF), or an Interrogating CSCF (I-CSCF). For example, a P-CSCF may provide a first contact point for the WTRU within the IMS, a S-CSCF may handle session states, and a I-CSCF may provide a contact point within an operator's network for IMS connections destined to a subscriber of that network operator, or to a roaming subscriber currently located within that network operator's service area.

The BGF 250 may include an Interconnection Border Control Function (IBCF), a Breakout Gateway Control Function (BGCF), or a Transition Gateway (TrGW). Although described as a part of the BGF, the IBCF, the BGCF, or the TrGW may each represent a distinct logical entity and may be located in one or more physical entities.

The IBCF may provide application specific functions at the SIP/SDP protocol layer to perform interconnection between operator domains. For example, the IBCF may enable communication between SIP applications, network topology hiding, controlling transport plane functions, screening of SIP signaling information, selecting the appropriate signaling interconnect, and generation of charging data records.

The BGCF may determine routing of IMS messages, such as SIP messages. This determination may be based on information received in the signaling protocol, administrative information, or database access. For example, for PSTN /CS Domain terminations, the BGCF may determine the network in which PSTN/CS Domain breakout is to occur and may select a MGCF.

The TrGW, may be located on the media path, may be controlled by an IBCF, and may provide network address and port translation, and protocol translation.

The MGF 260 may include a Media Gateway Control Function (MGCF), a Multimedia Resource Function Controller (MRFC), a Multimedia Resource Function Processor (MRFP), an IP Multimedia Subsystem—Media Gateway Function (IMS-MGW), or a Media Resource Broker (MRB). Although described as a part of the MGF, the MGCF, the MRFC, the MRFP, the IMS MGW, or the MRB may each represent a distinct logical entity and may be located in one or more physical entities.

The MGCF may control call state connection control for media channels in IMS; may communicate with CSCF, BGCF, and circuit switched network entities; may determine routing for incoming calls from legacy networks; may perform protocol conversion between ISUP/TCAP and the IM subsystem call control protocols; and may forward out of band information received in MGCF to CSCF/IMS-MGW.

The MRFC and MRFP may control media stream resources. The MRFC and MRFP may mix incoming media streams; may source media streams, for example for multimedia announcements; may process media streams, such as by performing audio transcoding, or media analysis; and may provide floor control, such as by managing access rights to shared resources, for example, in a conferencing environment.

The IMS-MGW may terminate bearer channels from a switched circuit network and media streams from a packet network, such as RTP streams in an IP network. The IMS-MGW may support media conversion, bearer control and payload processing, such as, codec, echo canceller, or conference bridge. The IMS-MGW may interact with the MGCF for resource control; manage resources, such an echo canceller; may include a codec. The IMS-MGW may include resources for supporting UMTS/GSM transport media.

The MRB may support the sharing of a pool of heterogeneous MRF resources by multiple heterogeneous applications. The MRB may assign, or releases, specific MRF resources to a call as requested by a consuming application, based on, for example, a specified MRF attribute. For example, when assigning MRF resources to an application, the MRB may evaluate the specific characteristics of the media resources required for the call or calls; the identity of the application; rules for allocating MRF resources across different applications; per-application or per-subscriber SLA or QoS criteria; or capacity models of particular MRF resources.

The SCC AS 270 may provide communication session service continuity, such as duplication, transfer, addition, or deletion of communication sessions, among multiple WTRUs, for example, in a subscription. The SCC AS may perform Access Transfer, Session Transfer or Duplication, Terminating Access Domain Selection (T-ADS), and Handling of multiple media flows. The SCC AS may combine or split media flows over one or more Access Networks. For example, a media flow may be split or combined for Session Transfers, session termination, upon request by the WTRU to add media flows over an additional Access Network during the setup of a session, or upon request by the WTRU to add or delete media flows over one or more Access Networks to an existing sessions.

A communication session may be performed using a communication system, such as the communication system shown in FIG. 1A, between a WTRU, such as the WTRU shown in FIG. 1B, and a remote device. The WTRU may access the communication system via a RAN, such as the RAN shown in FIG. 1C, or any other wired or wireless access network. The communication session may include services, such as IP multimedia (IM) services provided by the IMS as shown in FIG. 2.

The WTRU, the remote device, or the network may control the communication session. Control of the communication session may include, for example, starting or stopping a media flow, adding or removing a media flow, transferring or duplicating a media flow on another WTRU, adjusting a bit-rate, or terminating the communication. For example, a WTRU may initiate a communication session with a remote device. The WTRU may initially control the communication session. The WTRU may pass or share control of the communication session with the remote device.

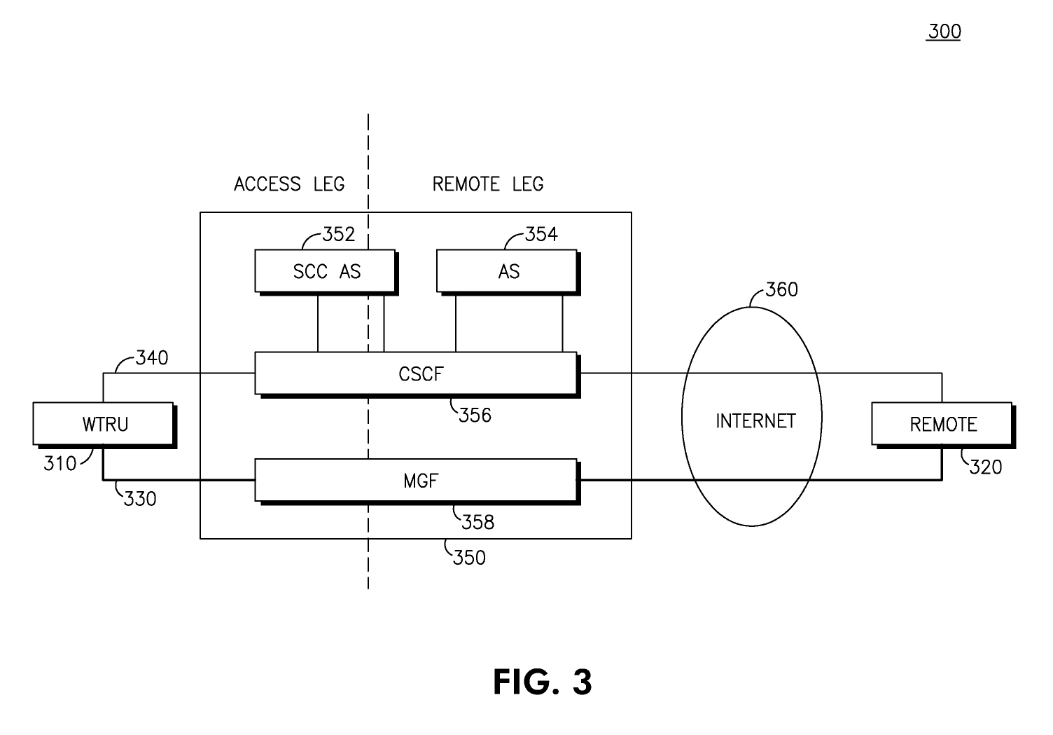

FIG. 3 shows a diagram of an example of a communication session 300 between a WTRU 310 and a remote device 320 using IMS . The communication session 300 may include media flows 330 (media path) and control signaling 340 (control path) between the WTRU 310 and the remote device 320 via a network 350, such as an IM CN as shown in FIG. 2. The IM CN 350 may include an SCC AS 352, an AS 354, a CSCF 356, and a MGF 358.

The communication session 300 may be anchored at the SCC AS 352 associated with the WTRU 310. For example, the SCC AS 352 may maintain information regarding the communication session, such as media flow identifiers and controlling device identifiers, and may provide call control for the communication session 300. For simplicity, the part of the communication session between the WTRU 310 and the SCC AS 352 may be referred to as the access leg, and the part of the communication session between the SCC AS 352 and the remote device 320 may be referred to as the remote leg.

To establish a communication session 300 using IMS the WTRU 310 may initiate a connection (access leg) via the IM CN 350. The WTRU 310 may receive the media flows 330 via the MGF 358 and control signaling 340 via the CSCF 356. The remote device 320 may participate in the communication session 300 via a remote network (remote leg), such as via the Internet 360.

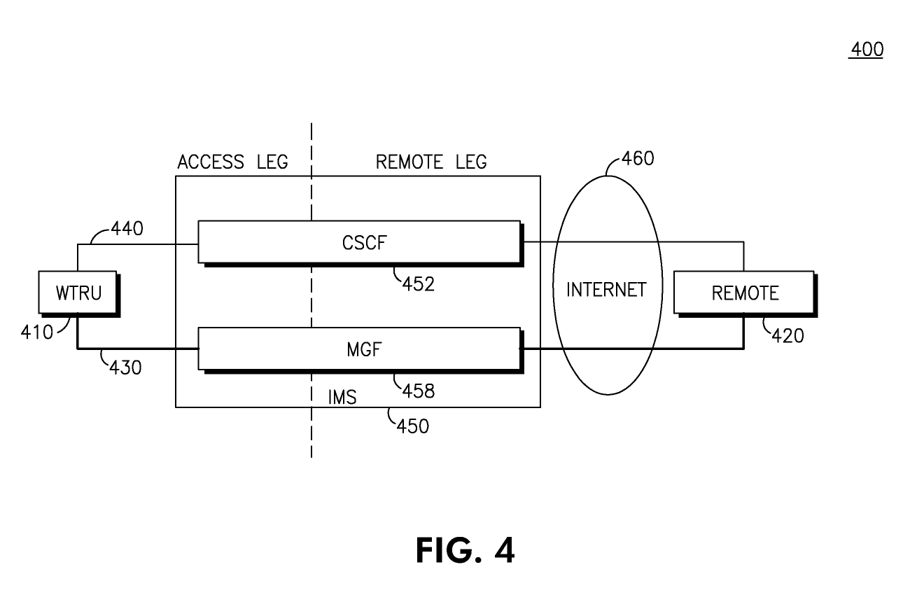

FIG. 4 shows a diagram of an example of a peer-to-peer communication session 400 between a WTRU 410 and a remote unit 420 using IMS. The communication session 400 may include media flows 430 and control signaling 440 established via a network, which may include an IM CN 450, such as the IM CN shown in FIG. 2. The IM CN 450 may include a CSCF 452 and a MGF 458. The WTRU 410 may also receive control signals and media flows directly from the remote device without the use of the IM CN.

To establish a communication session 400 using IMS the WTRU 410 may initiate a connection (access leg) via the IM CN 450. In the access leg, the WTRU 410 may receive the media flows 430 via the MGF 458 and control signaling 440 via the CSCF 452. The WTRU 410, the remote unit 420, or both may maintain the communication and perform call control functions for the communication session 400. The remote device 420 may participate in the communication session 400 via a remote network (remote leg), such as via the Internet 460.

The source WTRU and the target WTRU may be associated via a collaborative session, which may be anchored in a third party, such as the SCC AS.

The source WTRU may initially control the communication session, or may share control with the remote device. The source WTRU may pass control to the target WTRU or may share control with the target WTRU.

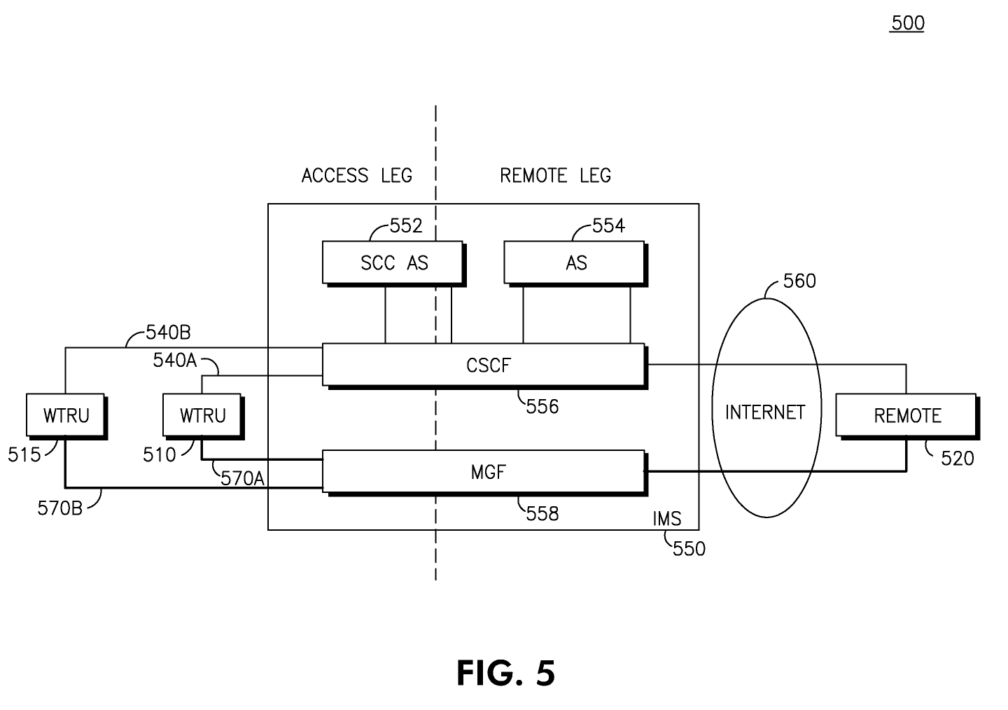

FIG. 5 shows a diagram of an example of a communication session 500. The source WTRU 510 and the target WTRU 515 may participate in the communication session 500 with the remote device 520 via a network 550, such as an IM CN as shown in FIG. 2. The IM CN 550 may include an SCC AS 552, an AS 554, a CSCF 556, and a MGF 558.

The communication session 500 may be anchored at the SCC AS 552 associated with the WTRU 510. For simplicity, the part of the communication session between the WTRUs 510/515 and the SCC AS 552 may be referred to as the access leg, and the part of the communication session between the SCC AS 552 and the remote device 520 may be referred to as the remote leg.

On the access leg, the source WTRU 510 and the target WTRU 515 may receive the duplicated media flows 570A/570B via the MGF 558 and the duplicated control signaling 540A/540B via the SCC AS 552 and the CSCF 556. The remote device 520 may participate in the communication session 500 via a remote network, such as via the Internet 560.

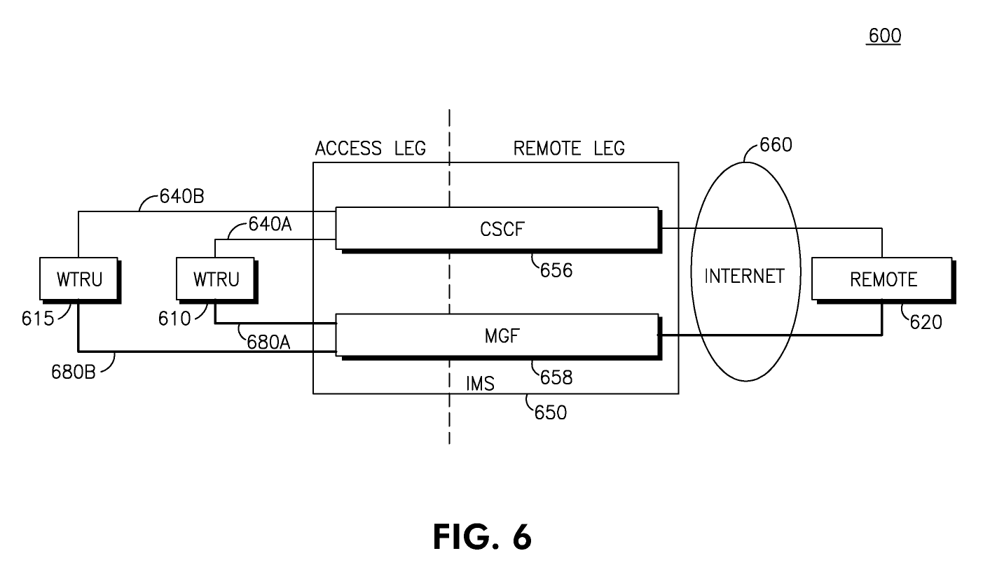

FIG. 6 shows a diagram of an example of a duplicated peer-to-peer communication session 600. The source WTRU 610 and the target WTRU 615 may participate in the duplicated peer-to-peer communication session 600 with the remote device 620 via a network 650, such as an IM CN as shown in FIG. 2. The IM CN 650 may include a CSCF 656, and a MGF 658.

For simplicity, the part of the communication session between the WTRUs 610/615 and the CSCF 656 may be referred to as the access leg, and the part of the communication session between the CSCF 656 and the remote device 620 may be referred to as the remote leg.

On the access leg, the source WTRU 610 and the target WTRU 615 may receive the duplicated media flows 680A/680B via the MGF 658 and the duplicated control signaling 640A/640B via the CSCF 656. The remote device 620 may participate in the communication session 600 via a remote network, such as via the Internet 660. Although FIG. 6 shows the media flow as being duplicated by the MGF 658, the media flows may be duplicated by the remote device 620, for example, using multiple transmitters.

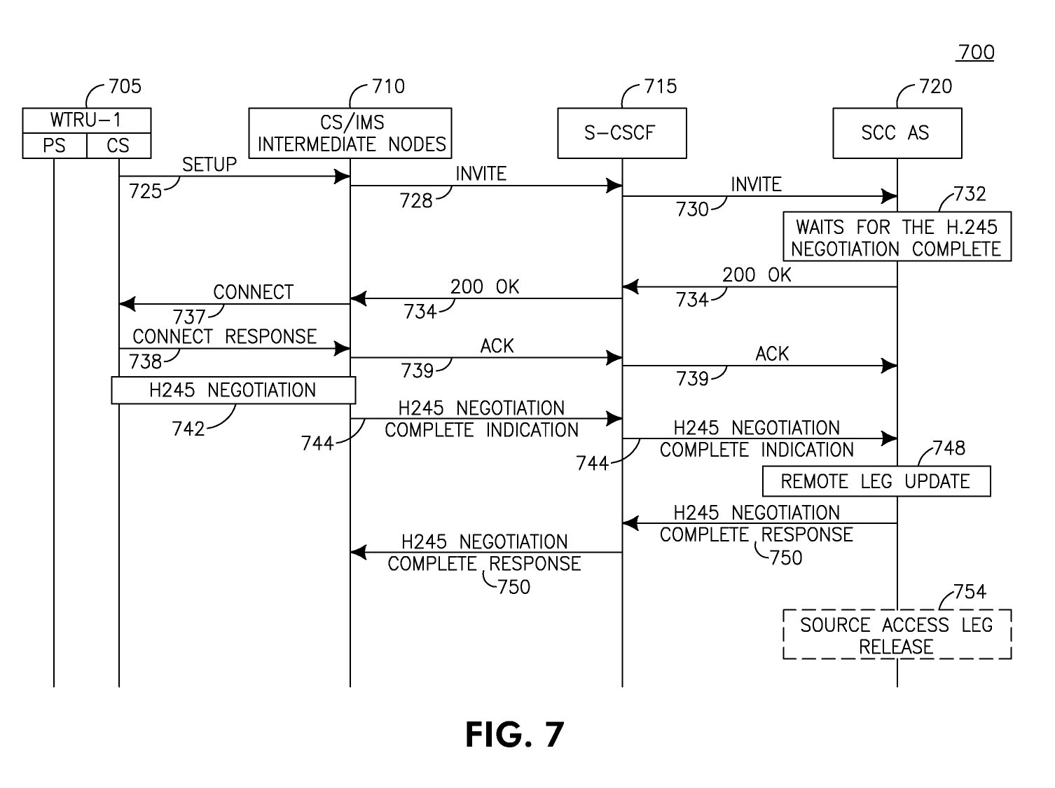

FIG. 7 shows an example of a transfer of session information (i.e., voice/video data) from a PS (packet switched) domain to a CS (circuit switched) domain 700. When a WTRU is active in an IMS session, the transfer of session information from the PS domain to the CS domain may provide service continuity.

Session transfer procedures initiated by the WTRU 705 are executed, controlled and anchored by the SCC AS 715. In order to execute a session transfer from the PS domain to the CS domain, the WTRU 705 sends information required by the SCC AS 720 and the SCC AS 720 maintains, for all active and inactive sessions, session state information.

A WTRU 705 may have both CS capabilities and PS capabilities. For the purpose of session transfer between a PS domain and a CS domain within the WTRU 705, the CS capable portion of the WTRU appears as IMS capable (able to communicate in the PS domain) through the use of an intermediary, a Circuit-Switched IMS Intermediate Node (CS IMS Node) 710. The CS IMS Node 710 may be one or more nodes that perform a translation of PS domain messages prior to transmission of the messages to the CS domain. The CS IMS Node 710 also performs a translation of CS domain messages prior to transmission of the messages in the PS domain. In addition, the CS IMS Node 710 may perform the functions of an IMS Media Gateway (MGW) and/or a mobile switching center (MSC) server.

The WTRU 705 starts the session transfer from a PS domain to a CS domain by sending a SETUP message 725. The SETUP message 725 establishes a CS access leg, which is a call control leg between the WTRU 705 and the SCC AS 720 using the CS IMS Node 710 as an intermediary. The CS IMS Node 710 may translate CS domain signals into IMS protocols for use in the PS domain, whereas PS domain signals are transmitted without translation via IMS protocols/signals.

Upon receipt of the SETUP message 725, the CS IMS Node 710 translates the CS WTRU signals via IMS protocols and sends a corresponding INVITE message 728 to the S-CSCF 715, which sends the INVITE message 730 to the SCC AS 720. The SCC AS 720 waits for a H.245 negotiation to be completed 732. The H.245 protocol is a control channel protocol used within communication sessions. It is capable of conveying information needed for multimedia communication, such as encryption, flow control, jitter management, preference requests, as well as the opening and closing of logical channels used to carry media streams. It also defines separate send and receive capabilities and the means to send these details to other devices.

The SCC AS 720 sends a 200 OK response 734 to the WTRU 705 via the S-CSCF 715 and the CS IMS Node 710. The CS IMS Node 710 sends a connection request 737 to the WTRU 705, which sends a connect response738 to the CS IMS Node 710. The CS IMS Node 710 sends an acknowledgment (ACK) 739 to the SCC AS 720 via the S-CSFC 715.

The WTRU 705 and the CS IMS Node 710 perform in-band H.245 negotiation 742. After the H.245 negotiation 742 is completed, the CS IMS Node 710 sends a H.245 negotiation completion indication 744 to the SCC AS 720 via the S-CSCF 715. The SCC AS 720 then updates the remote leg 748, a call control leg between the SCC AS 720 and the Remote Party, and sends a H.245 negotiation complete response 750 to the CS IMS Node 710 via the S-CSCF 715. The SCC AS 720 may then release the source access leg 754. The session transfer from the PS domain to the CS domain is complete.

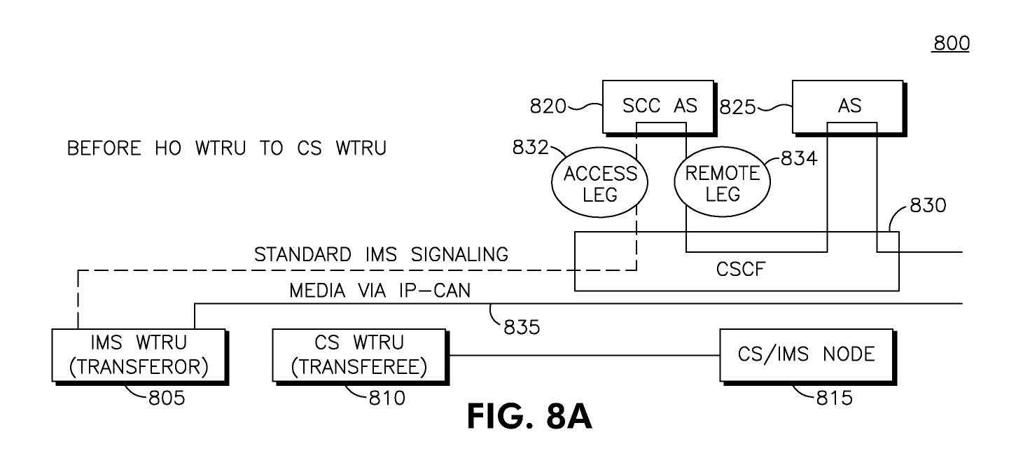

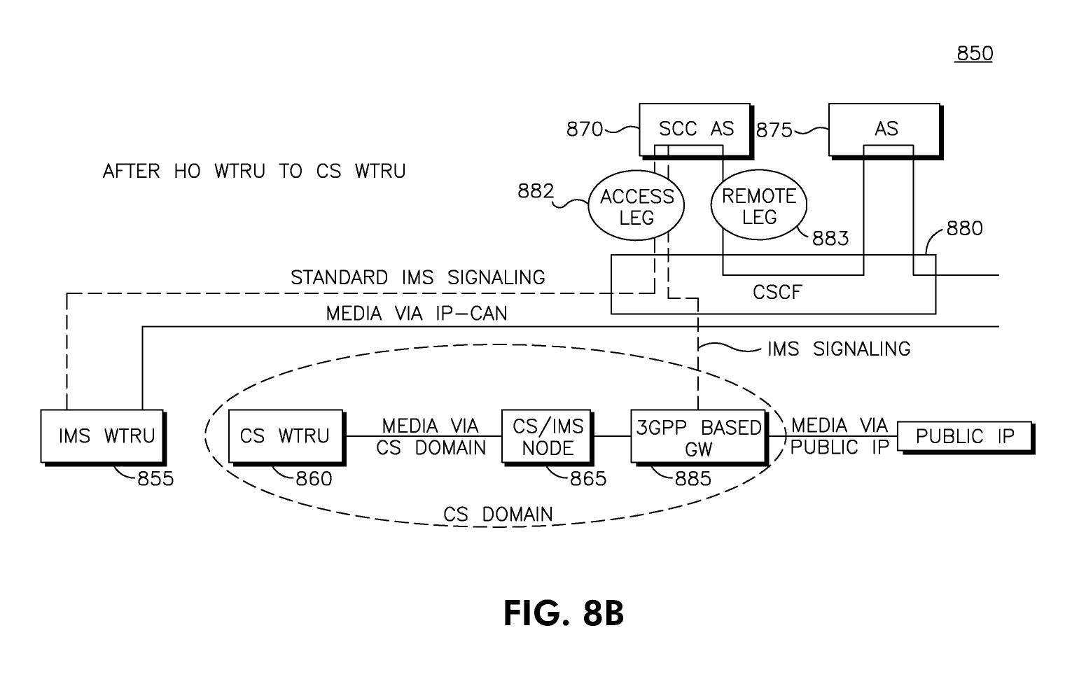

FIG. 8A shows an example architecture prior to handover (HO) of an IMS session 800 from an IMS-capable WTRU (transferor) 805 to a CS WTRU (transferee) 810. In this example, the IMS-capable WTRU 805 has an active IMS session via a control plane connection to a CSCF 830. The connection to the CSCF 830 is represented by the dashed line between the IMS-capable WTRU 805 and the CSCF 830. Control plane signaling, which may include the use of SIP messages, may take place on the connection between the transferring IMS-capable WTRU 805 and the CSCF 830. The SCC AS 820 may anchor the IMS session and the SCC AS 820 together with the Access Server (AS) 825 may manage the access leg 832 and remote leg 834 of the IMS session.

A data plane connection to an IP-CAN 835, which may be provided by a base station (i.e., Node-B or an e-NodeB (eNB)), may be established with the IMS-capable WTRU 805. The IMS-capable WTRU 805 may receive user plane media data via IMS and IP-CAN.

The CS WTRU 810 does not have an active IMS connection at this time. The CS WTRU 810 is connected to the CS IMS Node 815. The CS IMS Node 815 performs a translation of PS domain messages prior to transmission of the messages to the CS WTRU, and the CS IMS Node 815 performs a translation of CS domain messages prior to transmission of the messages in the PS domain.

FIG. 8B shows an example of architecture after HO of an IMS session 850 from an IMS-capable WTRU (transferor) 855 to a CS WTRU (transferee) 860. The transfer of the IMS session to the CS WTRU 860 may be based on predetermined criteria, user profiles, user input, or any other mechanism. The IMS-capable WTRU 855 continues to have an active IMS session via a control plane connection to the CSCF 880, but also communicates via IMS signaling with the CS WTRU 860 via the CS IMS Node 865. The SCC AS 870 may anchor the IMS session and the SCC AS 870 together with the Access Server (AS) 875 may manage the access leg 882 and remote leg 884 of the IMS session. The CS WTRU 860 communicates through the CS IMS Node 865 over a 3GPP based gateway 885 with the public IP. The CS IMS Node 865 translates the CS domain messages from the CS WTRU into IMS messages for transmission in the PS domain. The CS WTRU 860 receives PS domain messages, according the transferred IMS session, by using the CS IMS Node 865 as an intermediary to translate the PS domain messages into CS domain messages.

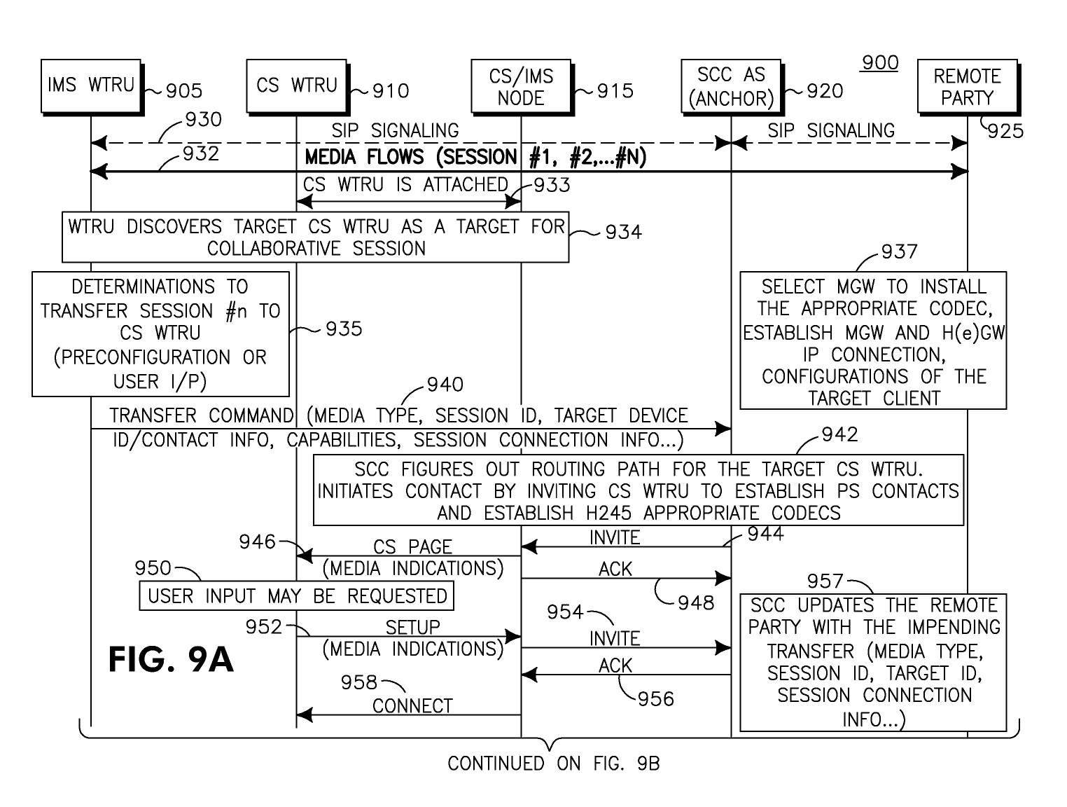

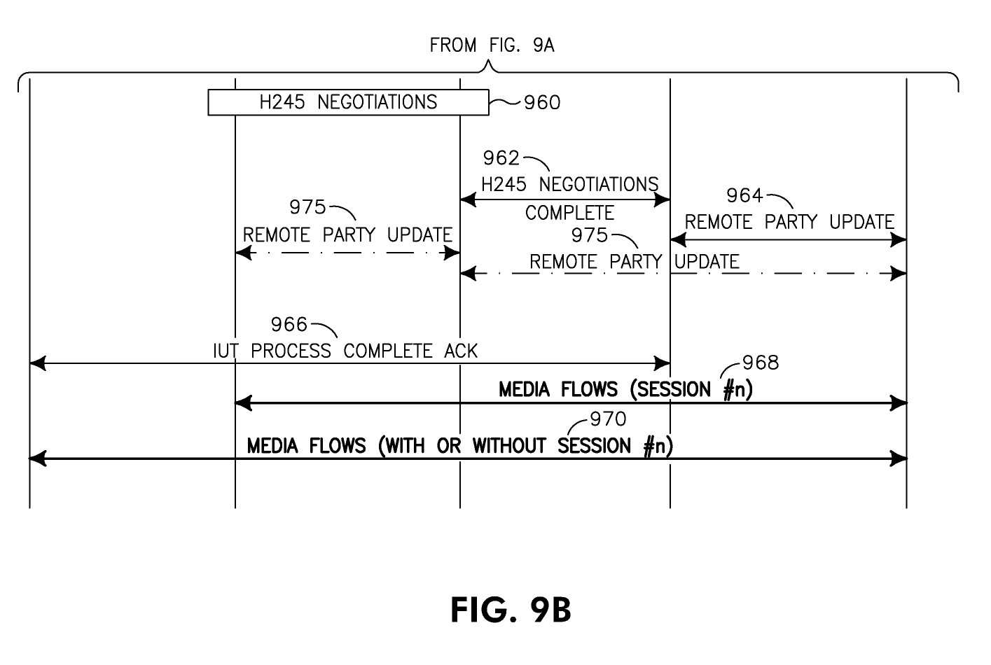

FIGS. 9A and 9B show an example of IUT of an IMS session 900 from an IMS-capable WTRU 905 to a CS WTRU 910, where the SCC AS 920 is used as an anchor to initiate a Remote Party 925 update. An IMS-capable WTRU 905 decides to initiate an IUT of an IMS session, or to initiate a collaborative session (i.e., two or more WTRUs sharing the same IMS session) with the CS WTRU 910.

For the purpose of IUT between an IMS-capable WTRU 905 and a CS WTRU 910, the CS WTRU 910 appears as an IMS WTRU through the use of an intermediary, a CS IMS Node 915. The CS IMS Node 915 may be in communication with 933 to the CS WTRU 910. The CS IMS Node 915 performs a translation of PS domain messages prior to transmission of the messages to the CS WTRU 910 and the CS IMS Node 915 performs a translation of CS domain messages prior to transmission of the messages in the PS domain.

Prior to initiating the IUT of a session, the IMS-capable WTRU 905 communicates using SIP signaling 930 with the Remote Party 925 via the SCC AS 920. The SIP messages may be IMS control plane messages. The IMS-capable WTRU 905, the SCC AS 920 and the Remote Party 925 may establish one or more media flows 932.

The IMS-capable WTRU 905 may discover that the CS WTRU 910 is a potential target for a collaborative session 934 and may decide to transfer an IMS session (i.e., session #n) 935 to the CS WTRU 910. This determination may be based on one or more preconfigured parameters or profiles and/or input from a user 935.

The IMS-capable WTRU 905 may send a transfer command message 940 to the SCC AS 920. The transfer command message 940 may include one or more parameters relating to either the CS WTRU 910 or IMS-capable WTRU 905 including but not limited to the following: 1) contact information; 2) device ID; 3) capability information; 4) a type of media; 5) a session ID; 6) session connection information; and 7) other parameters related to the session.

The SCC AS 920 may determine a routing path 942 for the CS WTRU 910 and may send an INVITE message 944 to the CS WTRU 910 via the CS IMS Node 915. The INVITE message 944 may relate to the SCC AS 920 inviting the CS WTRU 910 to establish PS and/or CS contacts and/or to establish H.245 appropriate Codecs.

The CS IMS Node 915 may send a CS page message 946 to the CS WTRU 910 and an acknowledgement 948 of the INVITE 944 to the SCC AS 920. The CS page message 946 may include information related to media formats and/or Codecs required by the CS WTRU 910 for receiving the IMS session data, and/or other information related to the IMS session. In addition, the identification of the transfer originator may also be included in the CS page message. The CS WTRU 910 may request input from a user 950 which may include whether the user accepts or rejects the transfer.

The CS WTRU 910 may send a set up message 952 to the CS IMS Node 915. The set up message 952 may relate to media formats and/or Codecs required by the CS WTRU 910 for receiving the IMS session data, and/or other information related to the IMS session. The CS IMS Node 915 may send a corresponding INVITE message 954 to the SCC AS 920. The SCC AS 920 may send an ACK message 956 to the CS IMS Node 915. The CS IMS Node 915 may send a message 958 to the CS WTRU 910 relating to a connection of the CS WTRU 910 to the IMS, the SCC AS 920, the Remote Party 925, and/or to one or more other network nodes or entities.

The CS WTRU 910 and the CS IMS Node 915 may perform H.245 negotiations 960. When the H.245 negotiations 960 are complete, the CS IMS Node 915 may send a message 962 to the SCC AS 920 indicating that the negotiations are complete. The SCC AS 920 and the Remote Party 925 then exchange one or more messages 964 to update the Remote Party 925 regarding the IMS session transfer. The messages exchanged may include one or more parameters including but not limited to the following: 1) contact information; 2) device ID; 3) capability information; 4) a type of media; 5) a session ID; 6) session connection information; and 7) other parameters related to the session. The Remote Party 925 may select an IMS Media Gateway (MGW) 937 in order to install appropriate Codecs and to establish a home evolved gateway (H(e)GW) IP connection with the configurations of the CS WTRU 910.

The SCC AS 920 sends an ACK 966 to the IMS-capable WTRU 905. The ACK message 966 may be an IMS IUT process complete message. A media flow 968 may be established between the CS WTRU 910 and the Remote Party 925. The IMS-capable WTRU 905 may continue to receive IMS data 970 from the Remote Party 925. The IMS data 970 received by the IMS-capable WTRU 905 may still include data according to session #n, or may not include session #n data.

At any point in the method of FIG. 9, additional actions may be performed between the IMS-capable WTRU 905, CS WTRU 910, CS IMS Node 915, SCC AS 920, and Remote Party 925 according to IMS IUT processes. Upon completion of the embodiment shown in FIG. 9, the CS WTRU 910 and IMS-capable WTRU 905 may participate in a collaborative session or the session may have been transferred to the CS WTRU 910.

In an alternative embodiment of FIG. 9, the CS IMS Node 915 is used as the anchor to initiate a Remote Party 925 update. In this embodiment, after the H.245 negotiations 962 are complete and prior to the SCC AS 920 sending an ACK 966 to the IMS-capable WTRU 905, the CS WTRU 910 may exchange one or more messages 975 with the Remote Party 925 via the CS IMS Node 915 to update the Remote Party 925 regarding the IMS session transfer. The messages 975 exchanged may include one or more parameters including but not limited to the following: 1) contact information; 2) device ID; 3) capability information; 4) a type of media; 5) a session ID; 6) session connection information; and 7) other parameters related to the session. In this embodiment the SCC AS 920 does not update 964 the Remote Party 925.

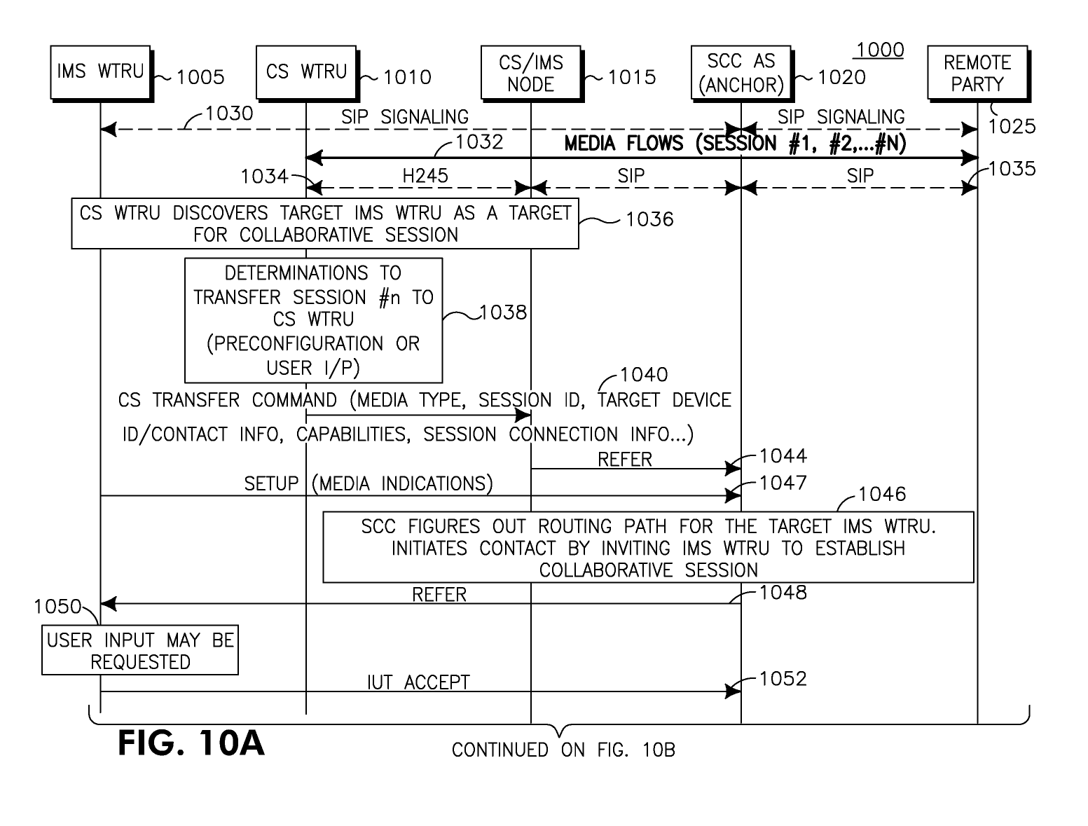

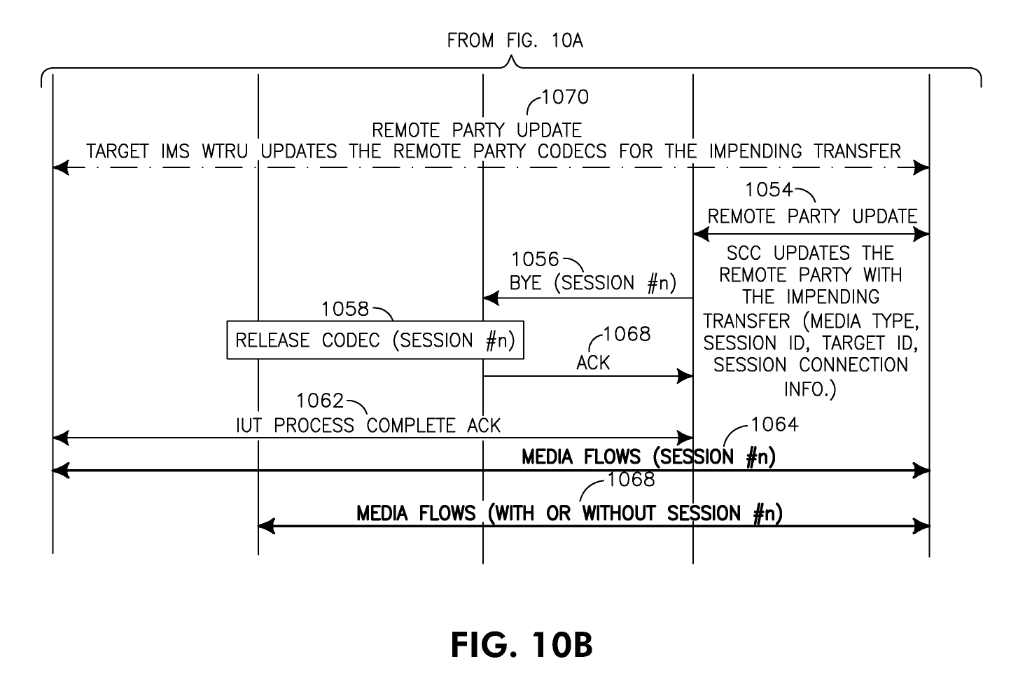

FIGS. 10A and 10B show an example of IUT of an IMS session 1000 from a CS WTRU 1010 to an IMS-capable WTRU 1005, where the SCC AS 1020 is used as an anchor to initiate a Remote Party 1025 update. A CS WTRU 1010 decides to initiate an IUT of an IMS session, or to initiate a collaborative session (i.e., two or more WTRUs sharing the same IMS session) with the IMS-capable WTRU 1005.

For the purpose of IUT between the CS WTRU 1010 and the IMS-capable WTRU 1005, the CS WTRU 1010 appears as a IMS WTRU through the use of an intermediary, the CS IMS Node 1015. The CS IMS Node 1015 may be the interface between the CS network/infrastructure and IMS infrastructure. The CS IMS Node 1015 performs a translation of PS domain messages prior to transmission of the messages to the CS WTRU 1010 and the CS IMS Node 1015 performs a translation of CS domain messages prior to transmission of the messages in the PS domain.

Prior to the commencement of session transfer, the IMS-capable WTRU 1005 communicates using SIP signaling 1030 with the Remote Party 1025 via the SCC AS 1020. The SIP messages may be IMS control plane messages.

The CS WTRU 1005, the SCC AS 1020 and the Remote Party 1025 may establish one or more media flows 1032. The CS WTRU 1010 and the CS IMS Node 1015 may perform H.245 negotiations 1034. When the H.245 negotiations 1034 are complete, the CS IMS Node 1015 may communicate using SIP signaling 1035 with the Remote Party 1025 via the SCC AS 1020.

The CS WTRU 1010 may discover 1036 that the IMS-capable WTRU 1005 is a potential target for a collaborative session and may decide to transfer an IMS session (i.e., session #n) 1038 to the IMS-capable WTRU 1005. This determination 1038 may be based on one or more preconfigured parameters, profiles, and/or input from a user. The CS WTRU 1010 may send a transfer command message 1040 to the CS IMS Node 1015. The transfer command message 1040 may include one or more parameters relating to either the CS WTRU 1010 or IMS-capable WTRU 1005 including but not limited to the following: 1) contact information; 2) device ID; 3) capability information; 4) a type of media; 5) a session ID; 6) session connection information; and 7) other parameters related to the session. The CS IMS Node 1015 may send a corresponding SIP REFER message 1044 to the SCC AS 1020.

The SCC AS 1020 may determine a routing path 1046 for the IMS-capable WTRU 1005 and may send a message 1048 inviting the IMS-capable WTRU 1005 to establish a collaborative session. The SCC AS 1020 may send a SIP REFER message 1048 to the IMS-capable WTRU 1005. The IMS-capable WTRU 1005 may send a set up message 1047 to the SCC AS 1020 that may relate to media formats and/or Codecs required by the IMS-capable WTRU 1005 for receiving the IMS session data, and/or other information related to the IMS session. The IMS-capable WTRU 1005 may also request user input 1050 and may send an IUT accept message 1052 to the SCC AS 1020.

The SCC AS 1020 and the Remote Party 1025 may exchange one or more messages 1054 to update the Remote Party 1025 regarding the IMS session transfer. The messages exchanged 1054 may include one or more parameters including but not limited to the following: 1) contact information; 2) device ID; 3) capability information; 4) a type of media; 5) a session ID; 6) session connection information; and 7) other parameters related to the session. The SCC AS 1020 may send a SIP BYE 1056 to the CS IMS Node 1015, indicating that session (i.e., session #n) is being transferred.

The CS WTRU 1010 and/or the CS IMS Node 1015 may release Codecs related to the session (i.e., session #n) 1058. The CS IMS Node 1015 may send an ACK 1068 to the SCC AS 1020. The SCC AS 1020 and the IMS-capable WTRU 1005 may then exchange one or more messages 1062 related to the completion of the transfer. These messages may include an IMS IUT process complete ACK message 1062.

A media flow 1064 may be established between the IMS-capable WTRU 1005 and the Remote Party 1025. The CS WTRU 1010 may continue to receive IMS data 1068 from the Remote Party 1025. The IMS data received by the CS WTRU 1010 may still include data according to the session (i.e., session #n), or may not include the session (i.e., session #n) data 1068.

At any point in the method of FIG. 10, additional actions may be performed between the IMS-capable WTRU 1005, CS WTRU 1010, CS IMS Node 1015, SCC AS 1020, and Remote Party 1025 according to IMS IUT processes. Upon completion of the embodiment shown in FIG. 10, the CS WTRU 1010 and IMS-capable WTRU 1005 may participate in a collaborative session or the session may have been transferred to the IMS-capable WTRU 1005.

In an alternative embodiment of FIG. 10, the CS IMS Node 1015 is used as the anchor to initiate a Remote Party 1025 update. In the alternative embodiment, after the IMS-capable WTRU 1005 sends an IUT accept message 1052 to the SCC AS 1020 and prior to the SCC AS sending a SIP BYE 1056 to the CS IMS Node 1015, the IMS-capable WTRU 1005 may exchange one or more messages 1070 with the Remote Party 1025 to update the Remote Party 1025 regarding the IMS session transfer. The messages exchanged 1070 may include one or more parameters including but not limited to the following: 1) contact information; 2) device ID; 3) capability information; 4) a type of media; 5) a session ID; 6) session connection information; 7) updated Codecs; and 8) other parameters related to the session. In this embodiment the SCC AS 1020 does not update 1054 the Remote Party 1025.

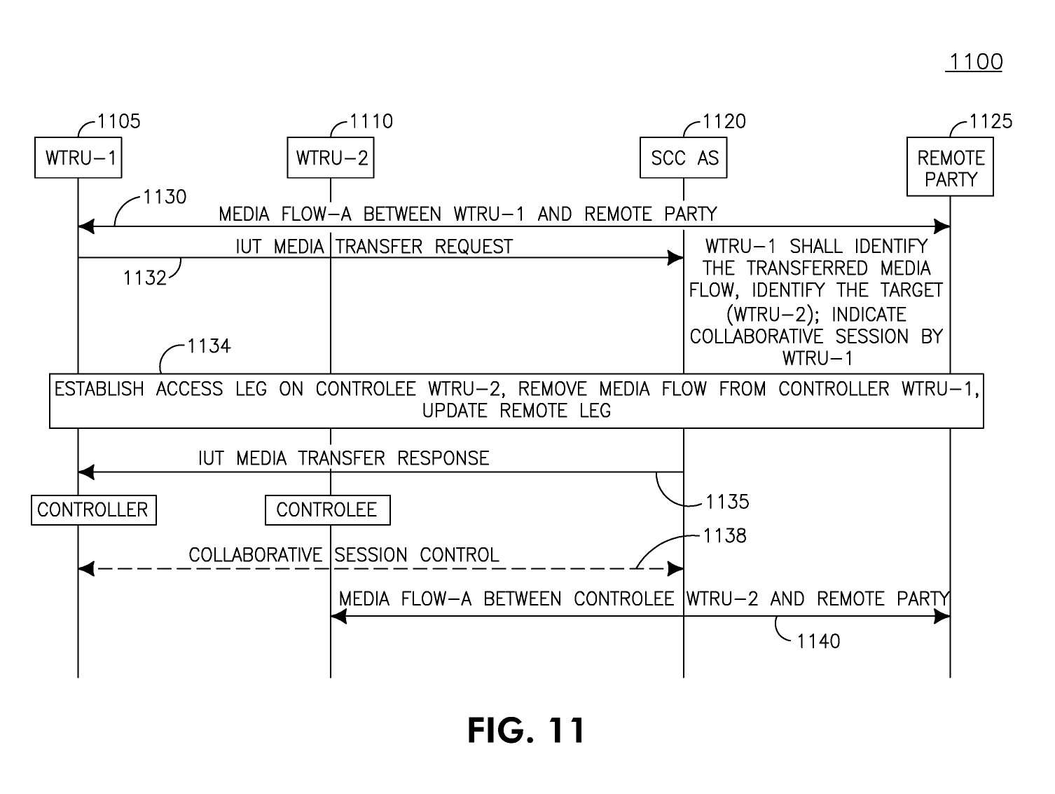

FIG. 11 shows an example of IUT of an IMS session 1100 from one IMS-capable WTRU 1105 to another IMS-capable WTRU 1110 in the same operator domain (i.e., IMS network), where the SCC AS 1120 is used as an anchor to initiate a Remote Party 1125 update. An IMS-capable WTRU 1105 decides to initiate an IUT of an IMS session, or to initiate a collaborative session (i.e., two or more WTRUs sharing the same IMS session) with another IMS-capable WTRU 1110. In the process, a collaborative session is created, with the initiator as the controller and the target as a controlee. A controller WTRU is a WTRU that initiates IUT procedures to establish a collaborative session with another WTRU. A controlee WTRU is any WTRU that is involved in a collaborative session but did not initiate the collaborative session.

Prior to initiating the IUT of a session, the controller WTRU 1105, the SCC AS 1120 and the Remote Party 1125 may establish one or more media flows 1130. The controller WTRU 1105 may discover that the controlee WTRU 1110 is a potential target for a collaborative session and may decide to transfer an IMS session to the controlee WTRU 1110. This determination may be based on one or more preconfigured parameters and/or input from a user.

The controller WTRU 1105 may send an IUT media transfer request 1132 to the SCC AS 1120. The media transfer request message 1132 may include one or more parameters including but not limited to the following: 1) a type of media; 2) target device ID; 3) session connection information; and 4) other parameters related to the session. The SCC AS 1120 removes the media flows 1134 from the controller WTRU 1105, establishes an access leg 1134 with the controlee WTRU 1110 and updates the remote leg 1134 to the Remote Party 1125. The SCC AS 1120 may send an IUT media transfer response 1135 to the controller WTRU 1105. The media transfer response may contain information such as the status of the IUT, media session attributes and the status of devices.

A collaborative session control 1138 may be established between the controller WTRU 1105 and the SCC AS1120. A media flow 1140 may be established between the controlee WTRU 1110 and the Remote Party 1125. The controller WTRU may continue to receive IMS data from the Remote Party. The IMS data received by the controller WTRU 1105 may still include data according to the session.

At any point in the method of FIG. 11, additional actions may be performed between the controller WTRU 1105, controlee WTRU 1110, SCC AS 1120, and Remote Party 1125 according to IMS IUT processes. Upon completion of the embodiment shown in FIG. 11, the controlee WTRU 1110 and controller WTRU 1105 may participate in a collaborative session or the session may have been transferred to the controlee WTRU 1110.

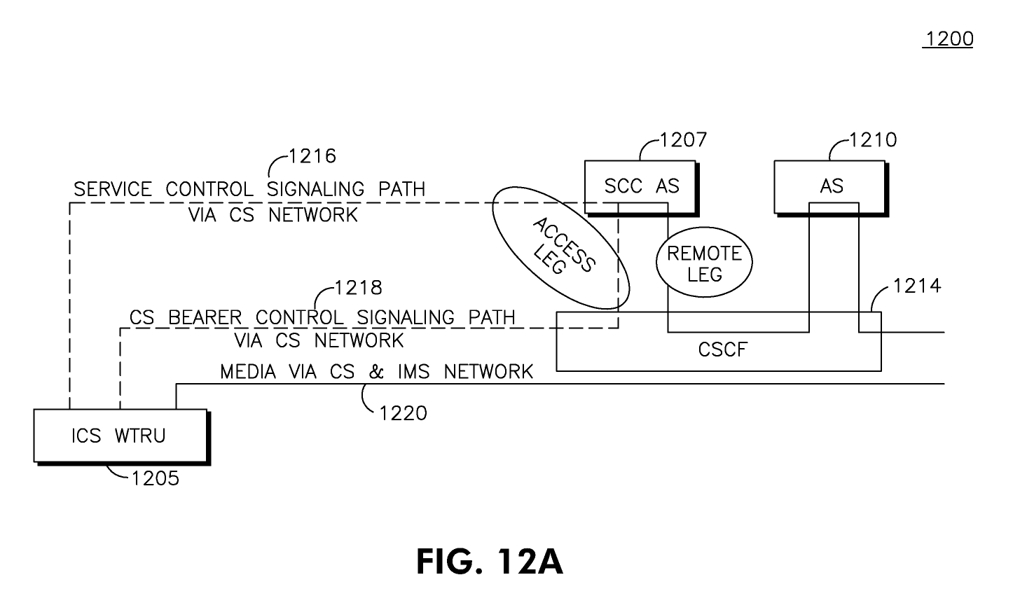

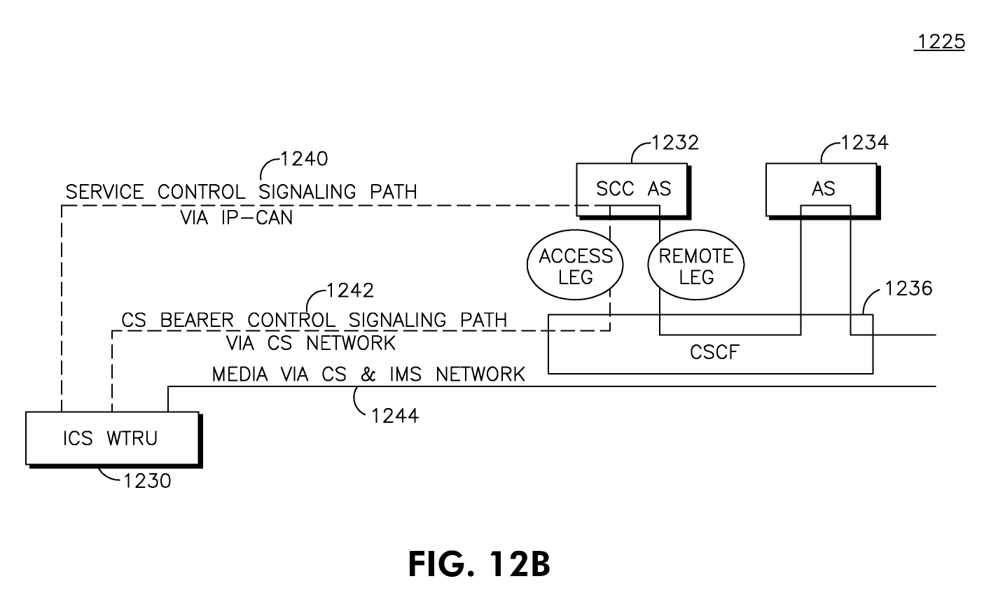

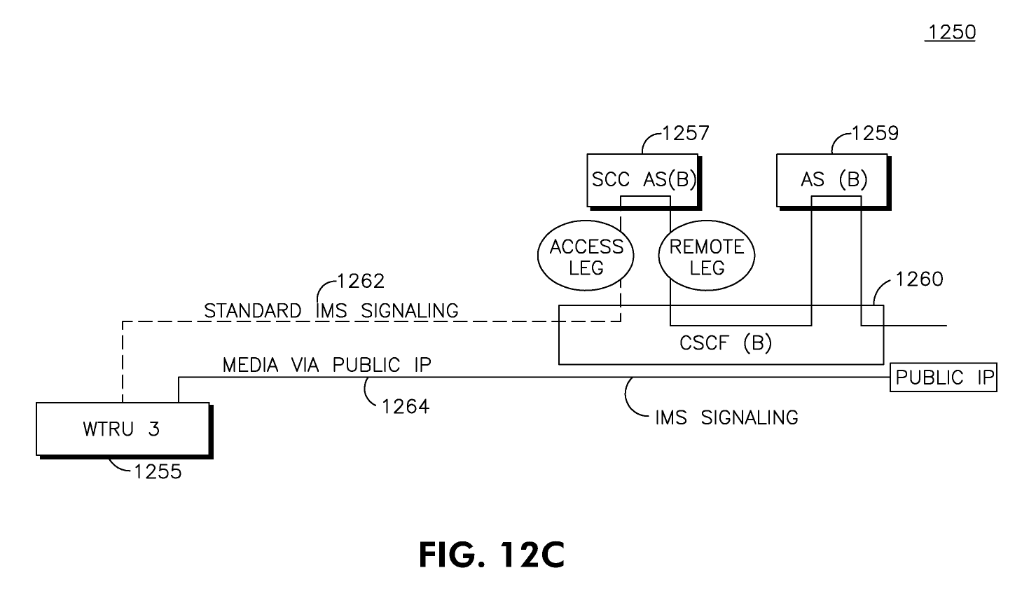

FIG. 12A shows an example of how signaling and bearer paths are combined and anchored 1200 at the SCC AS 1207 when the Service Control Signaling Path 1216 is established using an l1 reference point over a CS network before IUT.

In an IMS centralized services (ICS) session, the ICS WTRU 1205 may establish a Service Control Signaling Path 1216 for communication of service control signaling via the CS network using the Il reference point. The ICS WTRU 1205 may also establish a CS Bearer Control Signaling Path 1218 via the CS network using a control plane connection to a Call State Control Function (CSCF) 1214, which is an element in the IMS. This connection is represented by the dashed line between the ICS WTRU 1205 and the CSCF 1214. Control plane signaling, which may include the use of SIP messages, may take place on the connection between the ICS WTRU 1205 and the CSCF 1214.

The SCC AS 1207 combines the Service Control Signaling Path 1216 with the Bearer Control Signaling Path 1218 and anchors ICS sessions. The SCC AS 1207 provides service continuity among various WTRUs and together with the AS 1210 manage the access leg and remote leg of the ICS session for the ICS WTRU. The ICS WTRU 1205 may also receive media via the IMS network 1220.

FIG. 12B shows an example of how signaling and bearer paths are combined and anchored 1225 at the SCC AS 1232 when the Service Control Signaling Path 1240 is established using an Gm reference point over a PS network before IUT.

In an ICS session, the ICS WTRU 1230 may establish a Service Control Signaling Path 1240 for communication of service control signaling via the PS network using the Gm reference point. The ICS WTRU 1230 may also establish a CS Bearer Control Signaling Path 1242 via the CS network using a control plane connection to a CSCF 1236. This connection is represented by the dashed line between the ICS WTRU 1230 and the CSCF 1236. Control plane signaling, which may include the use of SIP messages, may take place on the connection between the ICS WTRU 1230 and the CSCF 1236.

The SCC AS 1232 combines the Service Control Signaling Path 1240 with the Bearer Control Signaling Path 1242 and anchors ICS sessions. The SCC AS 1232 provides service continuity among various WTRUs and together with the AS 1234 manage the access leg and remote leg of the ICS session for the ICS WTRU 1230. The ICS WTRU 1230 may also receive media via the IMS network 1244.

FIG. 12C shows an example of how signaling and bearer paths are combined and anchored 1250 at the SCC AS 1257 for sessions with PS media before IUT. The IMS-capable WTRU 1255 has an active IMS session 1262 using standard IMS signaling via a control plane connection to the CSCF 1260. The SCC AS 1257 may anchor the IMS session. The SCC AS 1257 together with the AS 1259 may manage the access leg and remote leg of the IMS session. The IMS-capable WTRU 1255 may also receive media via the IMS network 1264.

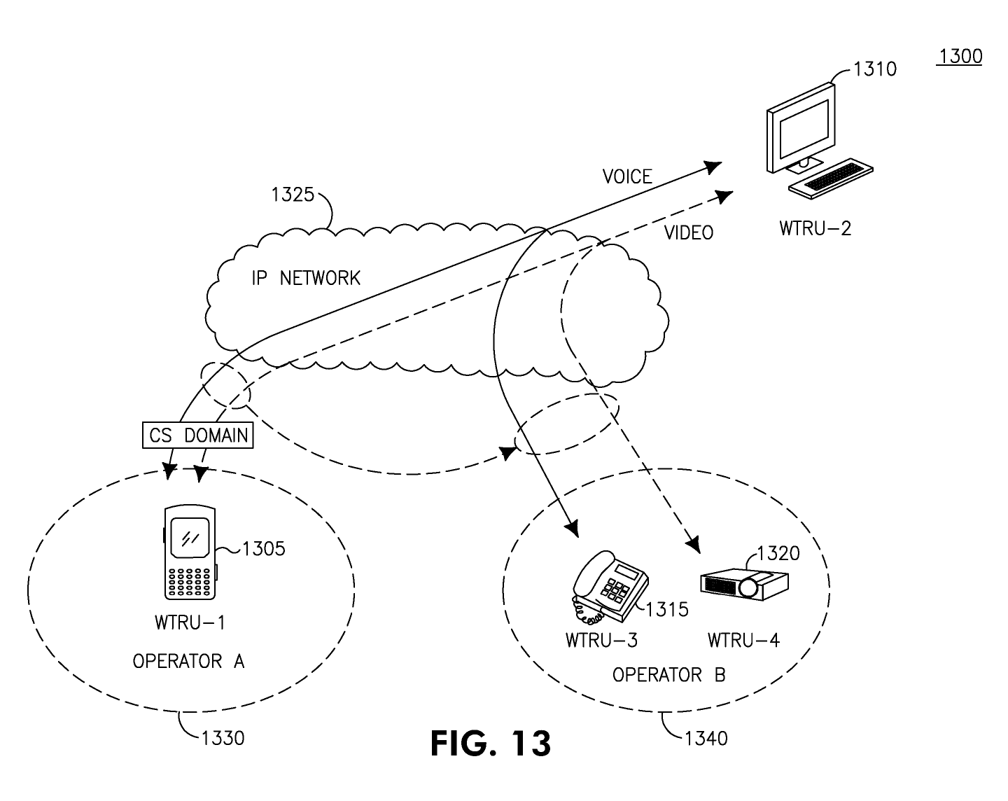

FIG. 13 is a high level diagram 1300 of IUT of IMS sessions between two or more operator domains 1330, 1340. WTRU-1 1305 is located in operator domain “A,” 1330 which may be a CS domain. WTRU-3 1315 and WTRU-4 1320 are located in operator domain “B,” 1340 which may be a CS domain or a PS domain. WTRU-2 1310 may be located in an operator domain other than operator domains A 1330 and B 1340.

WTRU-1 1305 decides to initiate an IUT of an IMS session, or to initiate a collaborative session with WTRU-2 1310. WTRU-1 1305 establishes a connection with WTRU-2 1310 over an IP network 1325 in order to transfer both voice and video session information. Similarly, WTRU-3 1315 and WTRU-4 1320 decide to initiate IUT of IMS sessions, or to initiate collaborative sessions with WTRU-2 1310. Both WTRU-3 1315 and WTRU-4 1320 establish a connection with WTRU-2 1310 over an IP network 1325 in order to transfer both voice and video session information.

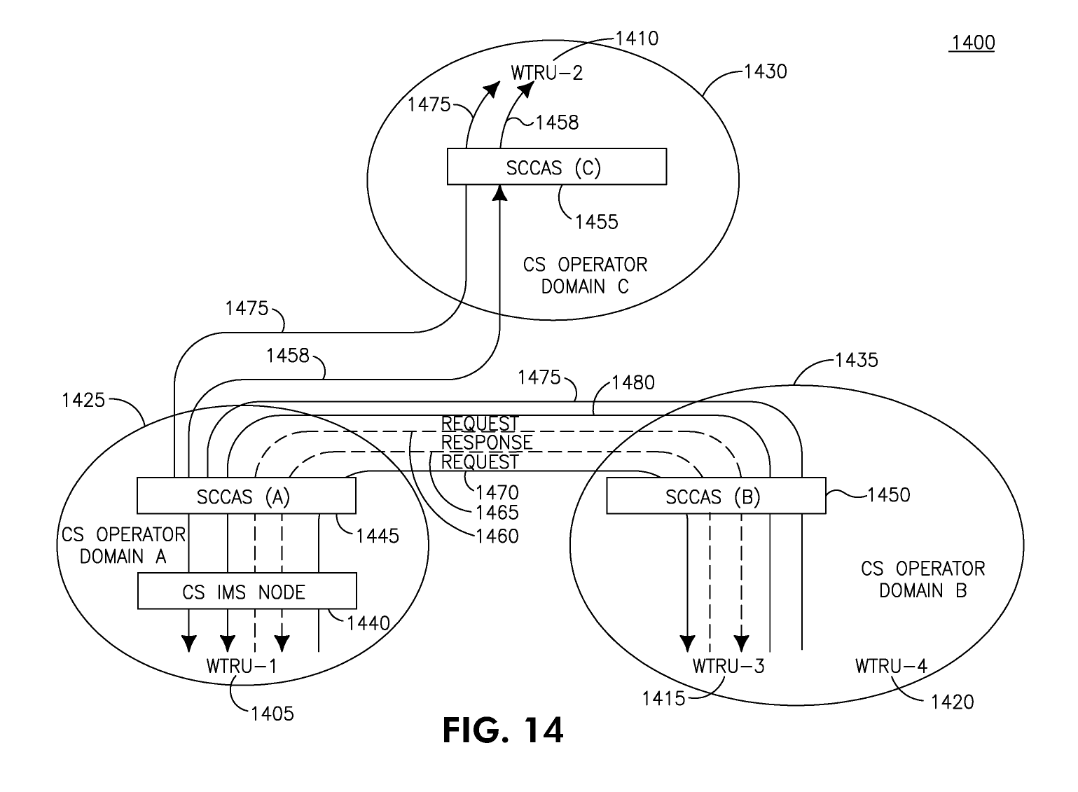

FIG. 14 shows a detailed diagram for IUT of IMS sessions 1400 between two or more operator domains. WTRU-1 1405 is located in operator domain “A,” 1425 which may be a CS domain. WTRU-3 1415 and WTRU-4 1420 are located in operator domain “B,” 1435 which may be a PS domain. WTRU-2 1410 is located in an operator domain “C,” 1430 which may be a PS domain.

WTRU-1 1405 is a CS WTRU. WTRU-1 1405 is in communication with a CS IMS Node 1440 located in operator domain A 1425, which acts as an intermediary between WTRU-1 1405 and SCC AS (A) 1445 also located in operator domain A 1425. SCC AS (A) 1445 anchors multimedia sessions and manages the access leg and remote leg of the IMS sessions 1458 shared with WTRU-2 1410.

WTRU-1 1405 determines that it wants to establish a collaborative IUT session with WTRU-3 1415. WTRU-1 1405 via the CS IMS Node 1440 and SCC AS (A) 1445 sends an availability request and a request for permission 1460 to transfer an IMS session to WTRU-3 1415. WTRU-3 1415 receives the request via SCC AS (B) 1450. WTRU-3 1415 may accept the transfer of some sessions and may reject some sessions by sending a response 1465 to WTRU-1 1405 via the SCC AS(B) 1450, which transmits the response to SCC AS (A) 1445. SCC AS(A) 1445 transmits the response 1465 to WTRU-1 1405 via CS IMS Node 1440.

WTRU-1 1405 may respond by sending a transfer request 1470 via the CS IMS Node 1440 to the SCC AS(A) 1445. The SCC AS (A) 1445 anchors the session and establishes a second access leg for the session via SCC AS (B) 1450 located in operator domain B 1435.

WTRU-3 1415 receives the request 1470 via SCC AS (B) 1450 and determines that it wants to share the session. WTRU-3 1415 invites WTRU-2 1410 to establish a collaborative session. WTRU-3 1415 sends an invite to WTRU-2 1410 via SCC AS (A) 1445, which is the anchor for the session, by first sending the invite to SCC AS (B) 1450. SCC AS (B) 1450 transmits the invite 1475 to SCC AS(A) 1445 and then SCC AS(A) 1445 transmits the message to SCC AS (C) 1455. SCC AS(C) 1455 then transmits the message to WTRU-2 1410, which may accept the collaborative session. The WTRU-2 1410 may send a response to WTRU-3 1415 via SCC AS (A) 1445, the anchor for the session by first sending the response to via SCC AS (C) 1455. SCC AS (C) 1455 transmits the response to SCC AS (A) 1445 and then SCC AS (A) 1445 transmits the message to SCC AS (B) 1450. SCC AS (B) 1450 then transmits the response to WTRU-3 1415. WTRU-3 1415 sends an ACK to WTRU-2 1410 via SCC AS (A) 1445, which by first sending the invite to SCC AS (B) 1450. SCC AS (B) 1450 transmits the ACK 1475 to SCC AS(A) 1445 and then SCC AS(A) 1445 transmits the ACK to SCC AS (C) 1455. SCC AS(C) 1455 then transmits the message to WTRU-2 1410.

WTRU-3 1415 sends a notification of the collaborative session 1480 with WTRU-2 1410 to SCC AS (A) 1445 via SCC AS(B) 1450. SCC AS (A) 1445 sends the notification 1480 of the collaborative session with WTRU-2 1410 to WTRU-1 1405 via the CS IMS Node 1440. On a condition that a non-collaborative session is established between WTRU-3 1415 and WTRU-2-1410, SCC AS (A) 1445 terminates WTRU-1's 1405 media via the CS IMS Node 1440.

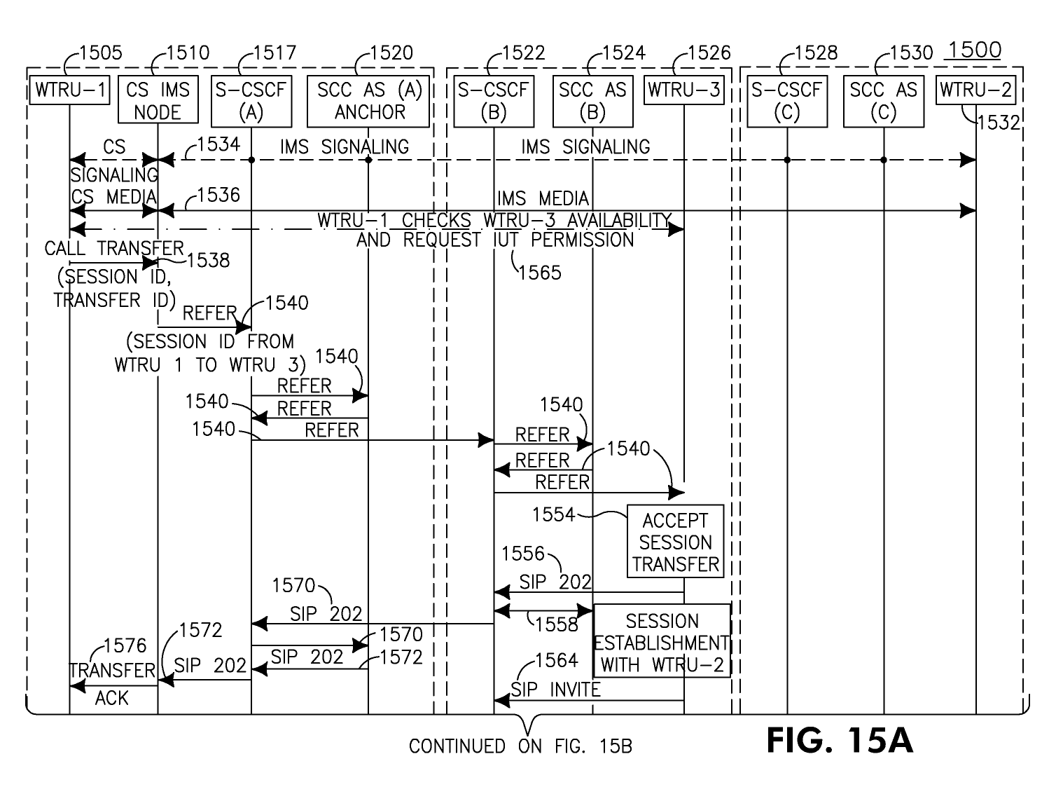

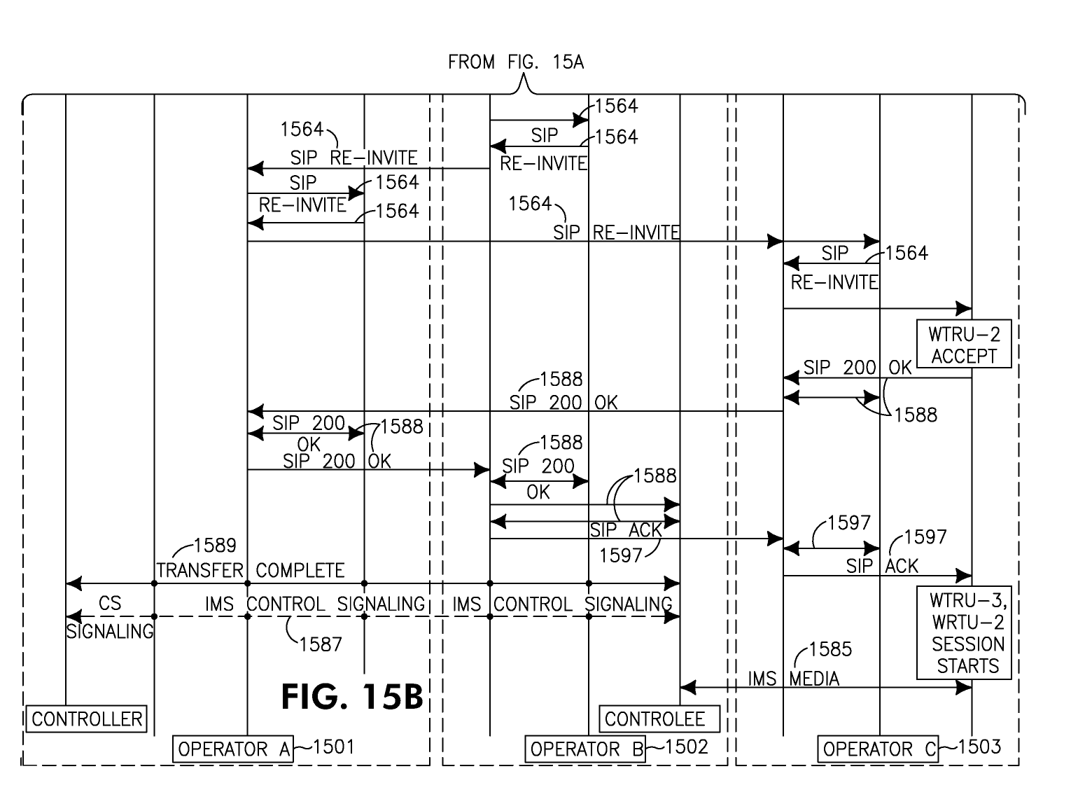

FIGS. 15A and 15B show an example of IUT of an IMS session 1500 from a CS WTRU 1505 in a CS operator domain, “A,” 1501 to an IMS-capable WTRU 1526 in a PS operator domain “B,” 1502 where the SCC AS (A) 1520 in the CS operator domain A, 1501 the source domain, is used as an anchor to initiate the session transfer to operator domain B, 1502 the target domain. By having the anchor in the source domain, the anchor before IUT remains the same after IUT. If the anchor is in the target domain, a more direct path for signaling between a target WTRU and a source WTRU exists.

For the purpose of IUT between the CS WTRU, WTRU-1 1505 and the IMS-capable WTRU, WTRU-3, 1526 the CS WTRU 1505 appears as a IMS WTRU through the use of an intermediary, the CS IMS Node 1510. The CS IMS Node 1510 may be in communication with WTRU-1 1505. The CS IMS Node 1510 performs a translation of PS domain messages prior to transmission of the messages to WTRU-1 1505 and the CS IMS Node 1510 performs a translation of CS domain messages prior to transmission of the messages in the PS domain.

Prior to the IUT of a session, WTRU-1 1505 communicates using CS signaling 1534 with the CS IMS Node 1510, which translates the CS signals to IMS signals, which are used to communicate with devices in operator domain “C,” 1503 which may be a PS domain.

WTRU-1 1505 via the CS IMS Node 1510 may establish one or more IMS media flows 1536 with WTRU-2, 1532 located in operator domain C 1503. WTRU-1 1505 decides to transfer an IMS session to WTRU-3, 1526 an IMS-capable WTRU in operator domain B 1502.

WTRU-1 the controller, 1505 sends a call transfer request 1538 including a session ID and a target ID to the CS IMS Node 1510. The CS IMS Node 1510 refers the call transfer request 1540, which includes the session ID from WTRU 1 1505 to WTRU 3 1526. The referral 1540 occurs when the CS IMS Node 1510 sends the refer request 1540 to the session anchor, SCC AS(A), 1520 via S-CSCF (A) 1517. The SCC AS (A) 1520 sends the refer request 1540 to the S-CSCF (A) 1517 for transmission of the refer request 1540 to S-CSCF(B) 1522 in operator domain B 1502 to establish the second access leg of the session. The S-CSCF (B) 1522 refers the request 1540 to SCC AS (B) 1524, also located in operator domain B, 1502 which then refers the request 1540 back to the S-CSCF (B) 1522 for transfer of the refer request 1540 to WTRU-3 1526.

The WTRU 3, the controlee, 1526 may accept the session transfer 1554 and may send via SIP 202 message 1556 indicating the acceptance to the SCC AS (B) 1524 via the S-CSCF (B) 1522. The S-CSCF (B) then communicates 1558 with the SCC AS (B) 1524 and transmits the SIP 202 message 1570 to the SCC AS (A) 1520 via S-CSCF (A) 1517. The SCC AS (A) 1520 transmits a SIP 202 message 1572 to the CS IMS Node 1510 via the S-CSCF (A) 1517. The transfer acknowledgment 1576 is sent from the CS IMS Node 1510 to WTRU-1 1505.

In operator domain B, 1502 WTRU 3 1526 sends a session establishment invite 1564 or a re-invite to WTRU-2 1532 in operator domain C 1503 through SCC AS (A), 1520 the session anchor, located in operator domain (A) 1501. This transmission occurs when the WTRU 3 1526 sends the SIP invite 1564 to the SCC AS (B) 1524 via S-CSCF (B) 1522. The SCC AS (B) 1524 then sends the invite 1564 to the SCC AS (A) 1520 via S-CSCF (B) 1522 which communicates with S-CSCF (A) 1517 to transmit the invite 1564 to SCC AS (A)1520. The SCC AS (A) 1520 sends the invite 1564 to the SCC AS (C) 1530 via S-CSCF (A) 1517 which communicates with S-CSCF (C) 1528 to transmit the invite 1564 to SCC AS (C) 1530.

The SCC AS (C) 1530 transmits the 1564 invite to WTRU-2 1532 via the S-CSCF(C) 1528. The WTRU 2 1532 may accept the invite 1564 and sends an “ok” message 1588 via SIP 200 to the SCC AS (C) 1530 via S-CSCF (C) 1528. The SCC AS (C) 1530 communicates the ok 1588 message to SCC AS (A) 1520 via S-CSCF (C) 1528 which communicates with S-CSCF (A) 1517 to transmit the ok 1588 to SCC AS (A) 1520. SCC AS (A) 1520 communicates the ok 1588 message to SCC AS (B) 1524 via S-CSCF (A) 1517 which communicates with S-CSCF (B) t1522 o transmit to ok message 1588 to SCC AS (B) 1524. SCC AS (B) 1524 then transmits the ok message 1588 to WTRU-3 1526 via S-CFCS (B) 1522. WTRU-3 1526 transmits a SIP ACK 1597 to WTRU-2 1532 in order to begin the session. The SIP ACK 1597 is transmitted by the WTRU-3 1526 via S-CSCF (B) 1522 which communicates with S-CSCF (C) 1528. The S-CSCF (C) 1528 sends the ACK 1597 to SCC AS (C) 1530. SCC AS (C) 1530 transmits the ACK 1597 to WTRU-2 1532 via S-CSCF (C) 1528.

WTRU-1 1505 and WTRU-3 1526 exchange transfer complete messages 1589 via the CS IMS Node 1510 using IMS service control signaling while WTRU-3 1526 and WTRU-2 1532 exchange IMS media.

In an alternative embodiment to FIG. 15, prior to WTRU-1 1505 sending a call transfer request 1538 to the CS IMS Node 1510, WTRU-1 1505 sends a request 1565 to WTRU-3 1526. The request message 1565 solicits availability information and IUT capability from WTRU-3 1526. WTRU-3 1526 may send a response with availability and IUT capability.

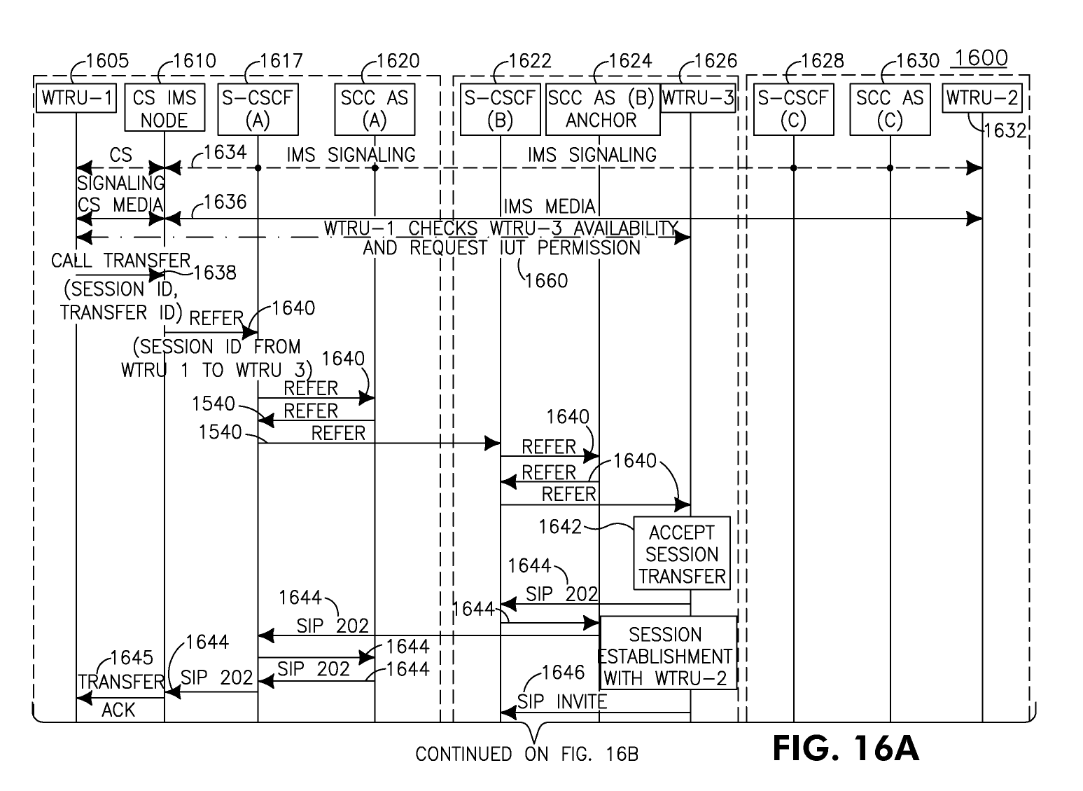

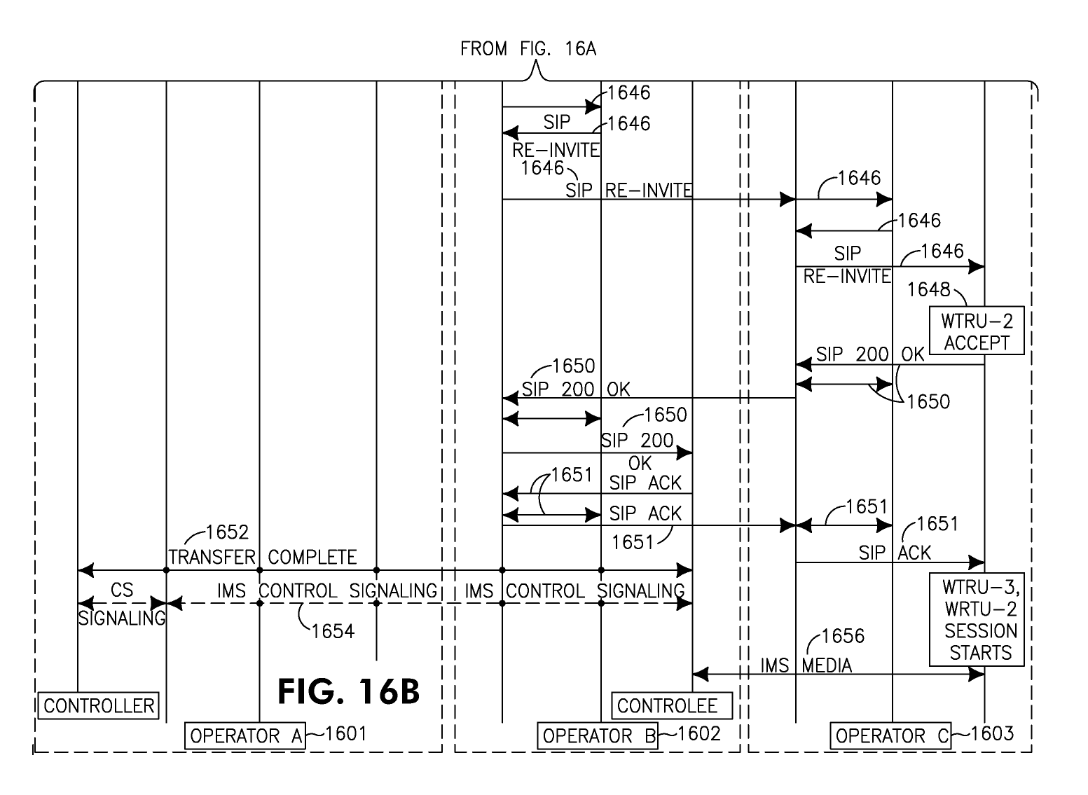

FIGS. 16A and 16B show an example of IUT of an IMS session 1600 from a CS WTRU 1605 in a CS operator domain, “A,” 1601 to an IMS-capable WTRU 1626 in a PS operator domain “B,” 1602 where the SCC AS (B) 1624 in the PS operator domain B, 1602 the target domain, is used as an anchor for session transfer from operator domain A, 1601 the source domain.

For the purpose of IUT between the CS WTRU, WTRU-1 1605 and the IMS-capable WTRU, WTRU-3, 1626 the CS WTRU 1605 appears as a IMS WTRU through the use of an intermediary, the CS IMS Node 1610. The CS IMS Node 1610 may be in communication with WTRU-1 1605. The CS IMS Node 1610 performs a translation of PS domain messages prior to transmission of the messages to WTRU-1 1605 and the CS IMS Node 1610 performs a translation of CS domain messages prior to transmission of the messages in the PS domain.

Prior to the IUT of a session, WTRU-1 1605 communicates using CS signaling 1634 with the CS IMS Node 1610, which translates the CS signals to IMS signals, which are used to communicate with devices in operator domain “C,” 1603 which may be a PS domain.

WTRU-1 1605 via the CS IMS Node 1610 may establish one or more IMS media flows 1636 with WTRU-2, 1632 located in operator domain C 1603. WTRU-1 1605 decides to transfer an IMS session to WTRU-3 1626, an IMS-capable WTRU in operator domain B 1602.

WTRU-1 the controller, 1605 sends a call transfer request 1638 including a session ID and a target ID to the CS IMS Node 1610. The CS IMS Node 1610 refers the call transfer request 1638, which includes the session ID from WTRU 1 1605 to WTRU 3 1626. The referral occurs when the CS IMS Node 1610 sends the refer request 1640 to the session anchor, SCC AS(A), 1620 via S-CSCF (A) 1617. The SCC AS (A) 1620 sends the refer request 1640 to the S-CSCF (A)1617 for transmission of the refer request 1640 to S-CSCF(B) 1622 in operator domain B 1602 to establish the second access leg of the session. The S-CSCF (B) 1622 refers the request 1640 to SCC AS (B), 1624 also located in operator domain B, 1602 which then refers the request back to the S-CSCF (B) 1622 for transfer of the refer request 1640 to WTRU-3 1626.

The WTRU 3, the controlee, 1626 may accept the session transfer 1642 and may transmit a SIP 202 message 1644 indicating the acceptance to the SCC AS (B) 1624 via the S-CSCF (B) 1622. The SCC AS (B) 1624 transmits SIP 202 message 1644 to the SCC AS (A) 1620 via S-CSCF (A) 1617. The SCC AS (A) 1620 transmits the SIP 202 message1644 to the CS IMS Node 1610 via the S-CSCF (A) 1617. The transfer acknowledgment 1645 is sent from the CS IMS Node 1610 to WTRU-1 1605.

In operator domain B, 1602 WTRU 3 1626 sends a session establishment invite 1646 or a re-invite to WTRU-2 1632 in operator domain C 1603 through SCC AS (B), 1624 the session anchor located in operator domain (B) 1602. This transmission occurs when the WTRU-3 1626 sends a SIP invite 1646 to the SCC AS (B) 1624 via S-CSCF (B) 1622. The SCC AS (B) 1624 then sends the invite 1646 to the SCC AS (C) 1630 via S-CSCF (B) 1622 which communicates with S-CSCF (C) 1628 to transmit the invite 1646 to SCC AS (C) 1630. The SCC AS (C) 1630 sends the invite 1646 WTRU-2 1632 via S-CSCF (C) 1628.

The WTRU 2 may accept the invite 1648 and sends an “ok” message 1650 via SIP 200 to the SCC AS (C) 1630 via S-CSCF (C) 1628. The SCC AS (C) 1630 communicates the ok message 1650 to SCC AS (B) 1624 via S-CSCF (C) 1628 which communicates with S-CSCF (B) 1622 to transmit the ok 1650 to SCC AS (B) 1624. SCC AS (B) 1624 then transmits the ok message 1650 to WTRU-3 1626 via S-CFCS (B)1622. WTRU-3 1626 transmits a SIP ACK 1651 to WTRU-2 1632 in order to begin the session. The SIP ACK 1651 is transmitted by the WTRU-3 1626 to SCC AS (B) 1624 via S-CSCF (B) 1622. SCC AS (B) 1624 transmits the SIP ACK 1651 via S-CSCF(B) 1622 which communicates with S-CSCF (C) 1628. The S-CSCF (C) 1628 sends the ACK 1651 to SCC AS (C) 1630. SCC AS (C) 1630 transmits the ACK 1651 to WTRU-2 1632 via S-CSCF (C) 1628.

WTRU-1 1605 and WTRU-3 1626 exchange transfer complete messages 1652 via the CS IMS Node 1610 using IMS service control signaling 1654 while WTRU-3 1626 and WTRU-2 1632 exchange IMS media 1656.

In an alternative embodiment to FIG. 16, prior to WTRU-1 1605 sending a call transfer request 1638 to the CS IMS Node 1610, WTRU-1 1605 sends a request 1660 to WTRU-3 1626. The request message 1660 solicits availability information and IUT capability from WTRU-3 1626. WTRU-3 1626 may send a response with availability and IUT capability.

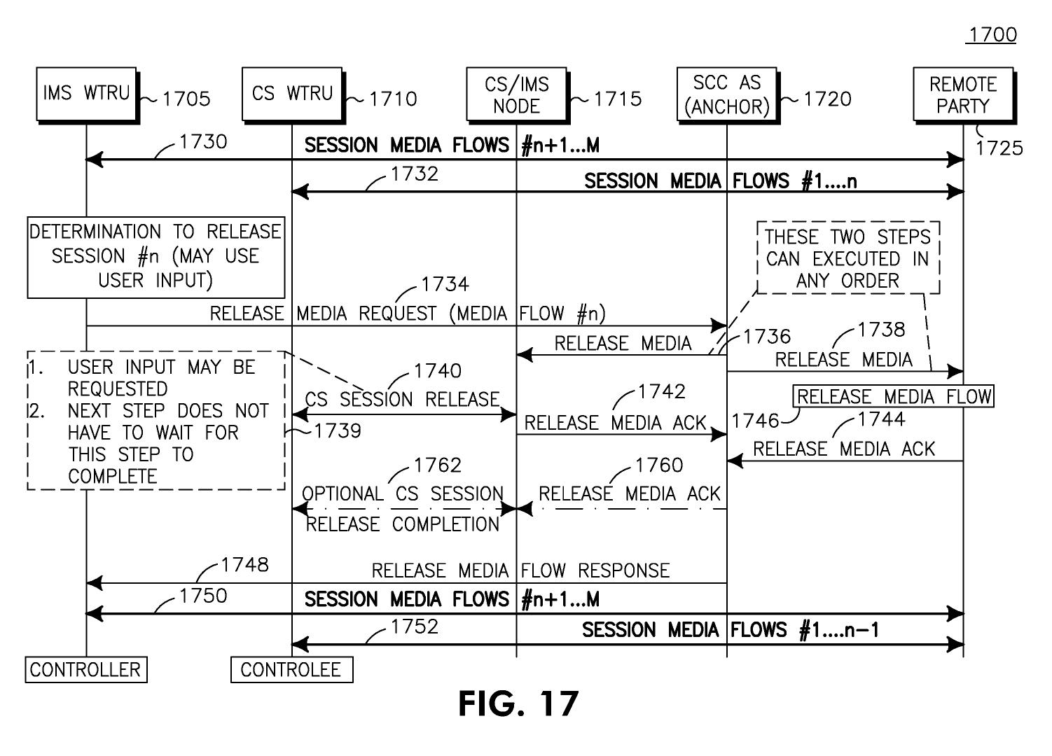

FIG. 17 shows an example of a media flow release within a collaborative IMS session 1700 between a IMS-capable WTRU 1705 and a CS WTRU 1710, where the SCC AS 1720 is an anchor for the session release initiated by the IMS-capable WTRU 1705 on the CS WTRU 1710.

For the purpose of media flow release within a collaborative session between the IMS-capable WTRU 1705 and the CS WTRU 1710, the CS WTRU 1710 appears as a IMS WTRU through the use of an intermediary, the CS IMS Node 1715. The CS IMS Node 1715 may be in communication with the CS WTRU 1710. The CS IMS Node 1715 performs a translation of PS domain messages prior to transmission of the messages to the CS WTRU 1710 and the CS IMS Node 1715 performs a translation of CS domain messages prior to transmission of the messages in the PS domain.

An IMS-capable WTRU, controller,1705 decides to release media flow within a collaborative session with a CS WTRU, controlee 1710. Prior to initiating the release, the IMS-capable WTRU 1705, CS WTRU 1710, the SCC AS 1720 and the Remote Party 1725 may establish one or more media flows 1730, 1732.

The IMS-capable WTRU 1705 may decide to release an IMS session with the CS WTRU 1710. This determination may be based on one or more preconfigured parameters and/or input from a user. The IMS-capable WTRU 1705 may send a release media request message 1734 including a media flow indicator to the SCC AS 1720, the anchor for the release. The SCC AS 1720 may send a release media message 1738 to the Remote Party and a release media message 1736 the CS WTRU 1710 via the CS IMS Node 1715. The CS WTRU 1710 may request 1739 user input prior to releasing the media. Once the media is released the Remote Party 1725 and the CS WTRU 1710, via the CS IMS Node 1715, send an acknowledgment 1742, 1744 respectively, to the SCC AS 1720. The SCC AS 1720 sends a media flow response 1748 to the IMS-capable WTRU 1705. The IMS-capable WTRU 1705 and the CS WTRU 1710 continue with the collaborative session with the remaining media flows 1750, 1752.

In an alternative embodiment to FIG. 17, after the media is released and the Remote Party 1725 and the CS WTRU 1710, via the CS IMS Node 1715, send an acknowledgment to the SCC AS, 1742, 1744 the SCC AS 1720 sends an ACK 1760 to the CS WTRU 1710 via the CS IMS Node 1715. The CS WTRU 1710 may exchange one or more messages CS Session Release Completion messages 1762 with the CS IMS Node 1715 since additional operations and communications may occur after media flow release (i.e., release radio and network resources).

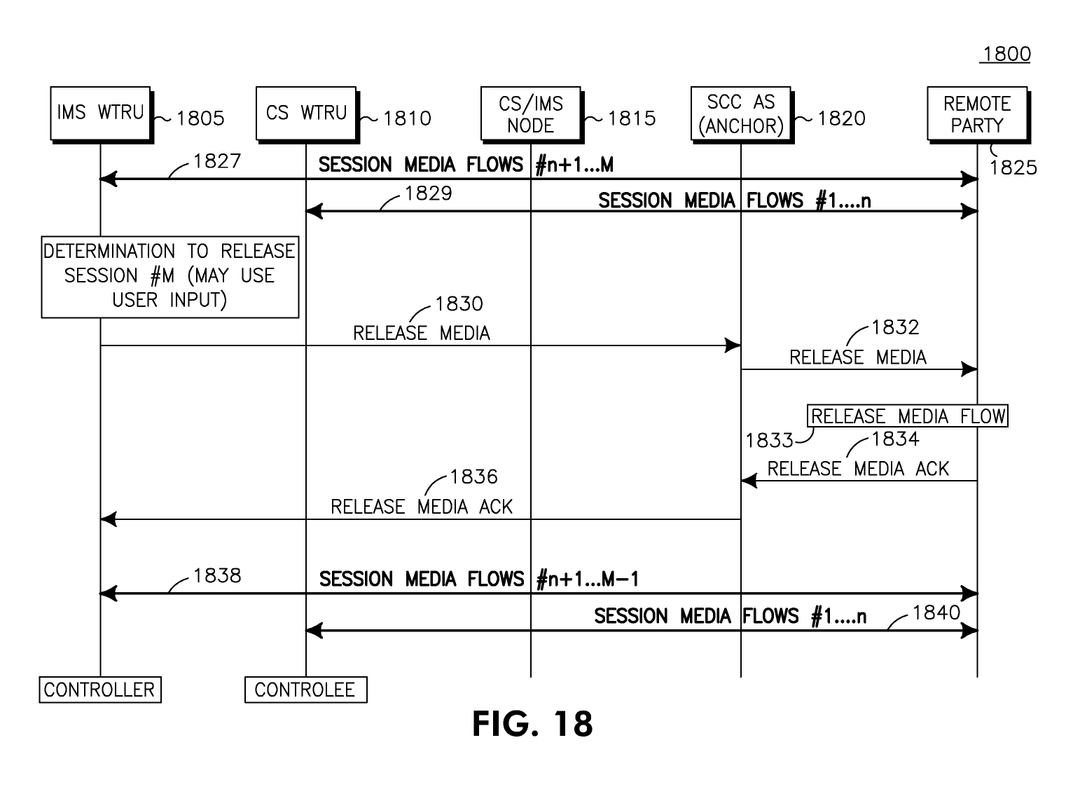

FIG. 18 shows an example of a media flow release within a collaborative IMS session 1800 between a IMS-capable WTRU 1805 and a CS WTRU 1810, where the SCC AS 1820 is an anchor for the session release initiated by the IMS-capable WTRU 1805 on itself.

An IMS-capable WTRU, controller,1805 decides to release media flow within a collaborative session with a CS WTRU, controlee 1810. Prior to initiating the release, the IMS-capable WTRU 1805, CS WTRU 1810, the SCC AS 1820 and the Remote Party 1825 may establish one or more media flows 1827, 1829.

The IMS-capable WTRU 1805 may decide to release an IMS session on itself. This determination may be based on one or more preconfigured parameters and/or input from a user. The IMS-capable WTRU 1805 may send a release media request message 1830 including a media flow indicator to the SCC AS 1820, the anchor for the release. The SCC AS 1820 may send a release media message 1832 to the Remote Party 1825. Once the media is released 1833 the Remote Party 1825 may send an acknowledgment 1834 to the SCC AS 1820. The SCC AS 1820 sends a media flow ACK 1836 to the IMS-capable WTRU 1805. The IMS-capable WTRU 1805 and the CS WTRU 1810 continue with the collaborative session with the remaining media flows 1838, 1840.

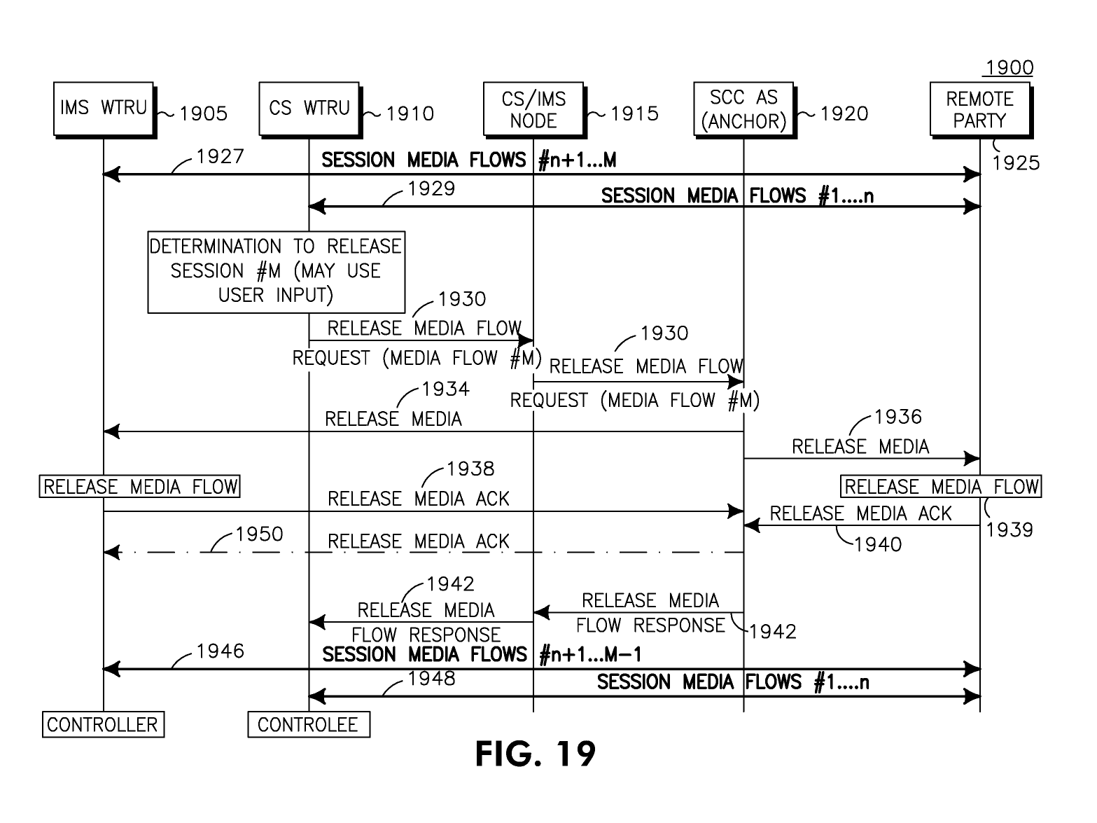

FIG. 19 shows an example of a media flow release 1900 within a collaborative IMS session between a IMS-capable WTRU 1905 and a CS WTRU 1910, where the SCC AS 1920 is an anchor for the session release initiated by the CS WTRU 1910 on the IMS-capable WTRU 1905.

For the purpose of media flow release within a collaborative session between the IMS-capable WTRU 1905 and the CS WTRU 1910, the CS WTRU 1910 appears as a IMS WTRU through the use of an intermediary, the CS IMS Node 1915. The CS IMS Node 1915 may be in communication with the CS WTRU 1910. The CS IMS Node 1915 performs a translation of PS domain messages prior to transmission of the messages to the CS WTRU 1910 and the CS IMS Node 1915 performs a translation of CS domain messages prior to transmission of the messages in the PS domain.

A CS WTRU, controlee, 1910 decides to release media flow within a collaborative session with an IMS-capable WTRU, controller 1905. Prior to initiating the release, the IMS-capable WTRU 1905, CS WTRU 1910, the SCC AS 1920 and the Remote Party 1925 may establish one or more media flows 1927, 1929.

The CS WTRU 1910 may decide to release an IMS session with the IMS-capable WTRU 1905. This determination may be based on one or more preconfigured parameters and/or input from a user. The CS WTRU 1910 may send a release media request message 1930 including a media flow indicator to the SCC AS 1920, the anchor for the release, via the CS IMS Node 1915. The SCC AS 1920 may send a release media message 1936 to the Remote Party and a release media message 1934 to the IMS-capable WTRU 1905. Once the media is released the Remote Party 1925 and the IMS-capable WTRU 1905 send an acknowledgment 1938, 1940, respectively, to the SCC AS 1920. The SCC AS 1920 sends a media flow response 1942 to the CS WTRU 1910 via the CS IMS Node 1915. The IMS-capable WTRU 1905 and the CS WTRU 1910 continue with the collaborative session with the remaining media flows 1946, 1948.

In an alternative embodiment to FIG. 19, after the media is released and the Remote Party 1925 and the IMS-capable WTRU 1905 send a release media message 1938, 1940, respectively, to the SCC AS 1920, the SCC AS 1920 sends a release media ACK 1950 to the IMS-capable WTRU 1905.

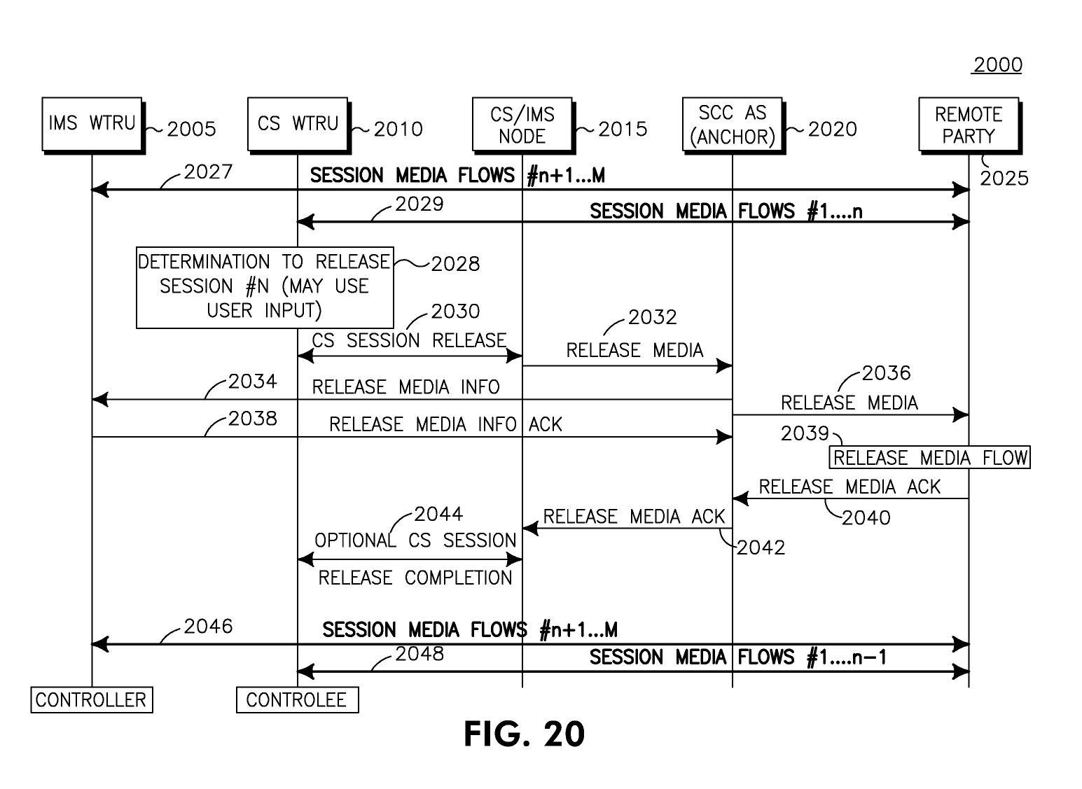

FIG. 20 shows an example of a media flow release within a collaborative IMS session 2000 between a IMS-capable WTRU 2005 and a CS WTRU 2010, where the SCC AS 2020 is an anchor for the session release initiated by the CS WTRU 2010 on itself.

For the purpose of media flow release within a collaborative session between the IMS-capable WTRU 2005 and the CS WTRU 2010, the CS WTRU 2010 appears as a IMS WTRU through the use of an intermediary, the CS IMS Node 2015. The CS IMS Node 2015 may be in communication with the CS WTRU 2010. The CS IMS Node 2015 performs a translation of PS domain messages prior to transmission of the messages to the CS WTRU and the CS IMS Node 2015 performs a translation of CS domain messages prior to transmission of the messages in the PS domain.

A CS WTRU, controlee 2010, decides to release media flow within a collaborative session with an IMS-capable WTRU, controller 2005. Prior to initiating the release, the IMS-capable WTRU 2005, CS WTRU 2010, the SCC AS 2020 and the Remote Party 2025 may establish one or more media flows 2027, 2029.

The CS WTRU 2010 may decide to release an IMS session on itself 2028. This determination may be based on one or more preconfigured parameters and/or input from a user. The CS WTRU 2010 may exchange CS session release messages 2030 with the CS IMS Node 2015. The CS IMS Node 2015 may send a release media message 2032 to the SCC AS 2020, the anchor for the release. The SCC AS 2020 may send a release media message 2036 to the Remote Party 2025 and a release media message 2034 to the IMS-capable WTRU 2005. Once the media is released 2039 the Remote Party 2025 sends a release media ACK 2040 and the IMS-capable WTRU 2005 sends a release media ACK 2038 to the SCC AS 2020. The SCC AS 2020 sends release media ACK 2042 to the CS WTRU 2010 via the CS IMS Node 2015. The CS WTRU 2010 may exchange one or more CS Session Release Completion messages 2044 with the CS IMS Node 2015. The IMS-capable WTRU 2005 and the CS WTRU 2010 continue with the collaborative session with the remaining media flows 2046, 2048.

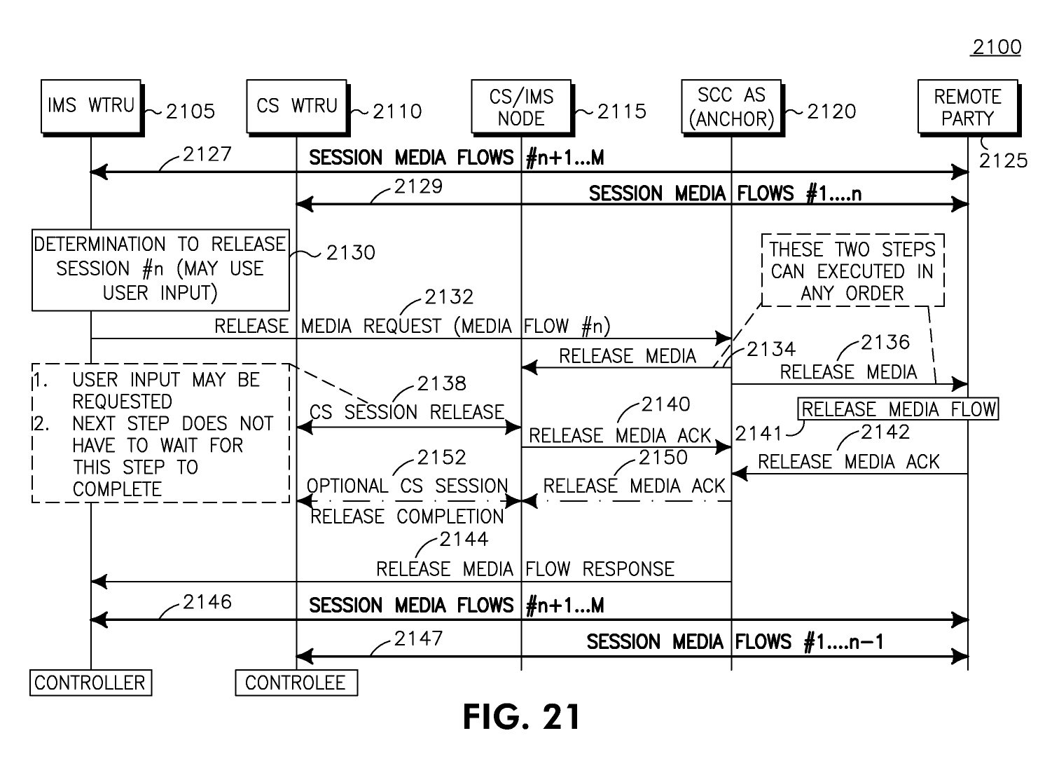

FIG. 21 shows an example of a media flow release within a collaborative IMS session 2100 between a IMS-capable WTRU 2105 and a CS WTRU 2110, where the SCC AS 2120 is an anchor for the session release initiated by the IMS-capable WTRU 2105 on the CS WTRU 2110. In this example the IMS-capable WTRU 2105 is the controlee and the CS WTRU is the controller.

For the purpose of media flow release within a collaborative session between the IMS-capable WTRU 2105 and the CS WTRU 2110, the CS WTRU 2110 appears as a IMS WTRU through the use of an intermediary, the CS IMS Node 2115. The CS IMS Node 2115 may be in communication with the CS WTRU 2110. The CS IMS Node 2115 performs a translation of PS domain messages prior to transmission of the messages to the CS WTRU 2110 and the CS IMS Node 2115 performs a translation of CS domain messages prior to transmission of the messages in the PS domain.

An IMS-capable WTRU, controlee 2105, decides to release media flow 2130 within a collaborative session with a CS WTRU, controller 2110. Prior to initiating the release, the IMS-capable WTRU 2105, CS WTRU 2110, the SCC AS 2120 and the Remote Party 2125 may establish one or more media flows 2127, 2129.

The IMS-capable WTRU 2105 may decide to release an IMS session 2130 with the CS WTRU 2110. This determination may be based on one or more preconfigured parameters and/or input from a user. The IMS-capable WTRU 2105 may send a release media request message 2132 including a media flow indicator to the SCC AS 2120, the anchor for the release. The SCC AS 2120 may send a release media message 2136 to the Remote Party 2125 and a release media message 2134 to the CS WTRU 2110 via the CS IMS Node 2115. The CS WTRU 2110 may request user input 2138 prior to releasing the media. Once the media is released 2141 the Remote Party 2125 sends a release media ACK 2142 to the SCC AS 2120. The CS WTRU 2110, via the CS IMS Node 2115, sends a release media ACK 2140 to the SCC AS 2120. The SCC AS 2120 sends a media flow response 2144 to the IMS-capable WTRU 2105. The IMS-capable WTRU 2105 and the CS WTRU 2110 continue with the collaborative session with the remaining media flows 2146, 2147.

In an alternative embodiment to FIG. 21, after the media is released 2141 and the Remote Party 2125 sends a release media ACK 2142 and the CS WTRU 2110, via the CS IMS Node 2115, sends a release media ACK 2140 to the SCC AS 2120, the SCC AS 2120 sends an ACK 2150 to the CS WTRU 2110 via the CS IMS Node 2115. The CS WTRU 2110 may exchange one or more CS Session Release Completion messages 2152 with the CS IMS Node 2115.

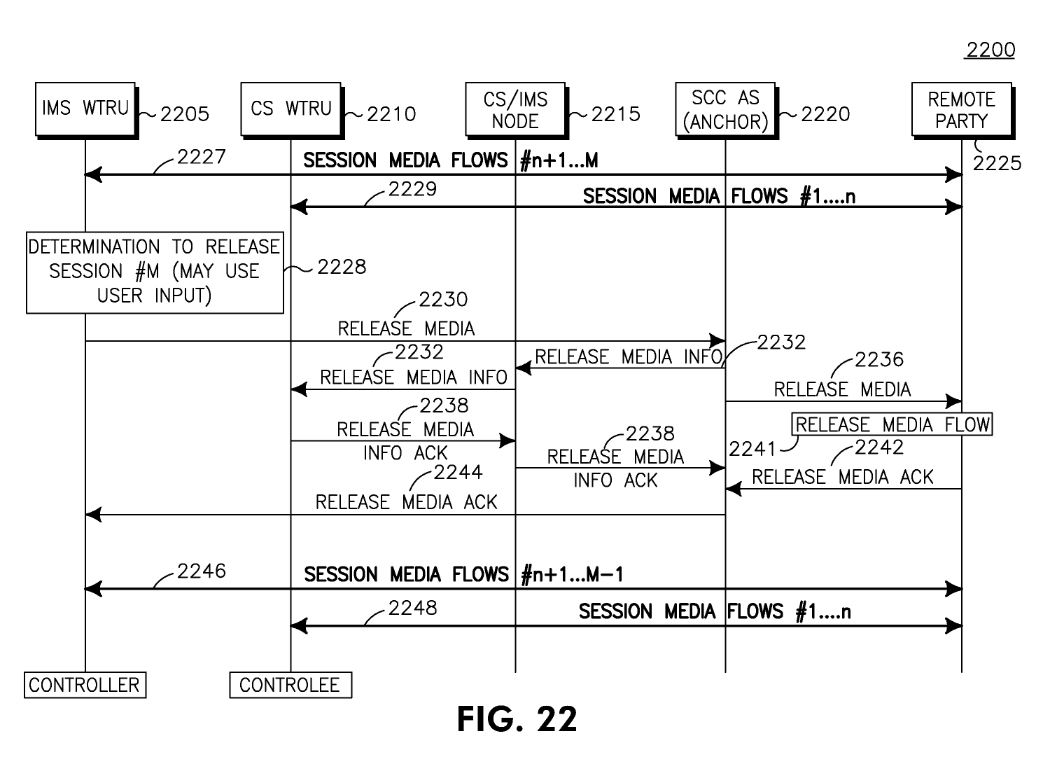

FIG. 22 shows an example of a media flow release within a collaborative IMS session 2200 between a IMS-capable WTRU 2205 and a CS WTRU 2210, where the SCC AS 2220 is an anchor for the session release initiated by the IMS-capable WTRU 2205 on itself. In this example the IMS-capable WTRU 2205 is the controlee and the CS WTRU 2210 is the controller.

An IMS-capable WTRU, controlee 2205, decides to release media flow 2228 within a collaborative session with a CS WTRU, controller 2210. Prior to initiating the release, the IMS-capable WTRU 2205, CS WTRU 2210, the SCC AS 2220 and the Remote Party 2225 may establish one or more media flows 2227, 2229.

The IMS-capable WTRU 2205 may decide to release an IMS session 2228 on itself. This determination may be based on one or more preconfigured parameters and/or input from a user. The IMS-capable WTRU 2205 may send a release media request message 2230 including a media flow indicator to the SCC AS 2220, the anchor for the release.

The SCC AS 2220 may send release media information 2232 to the CS WTRU 2210 via the CS IMS Node 2215. Once the media is released the SCC AS 2220 may receive a release media ACK 2238 from the CS WTRU 2220 via the CS IMS Node 2215.

The SCC AS 2220 may send a release media message 2236 to the Remote Party 2225. Once the media is released 2241 the Remote Party 2225 may send a release media ACK 2242 to the SCC AS 2220. The SCC AS 2220 may send a release media ACK 2244 to the IMS-capable WTRU 2205. The IMS-capable WTRU 2205 and the CS WTRU2210 continue with the collaborative session with the remaining media flows 2246, 2248.

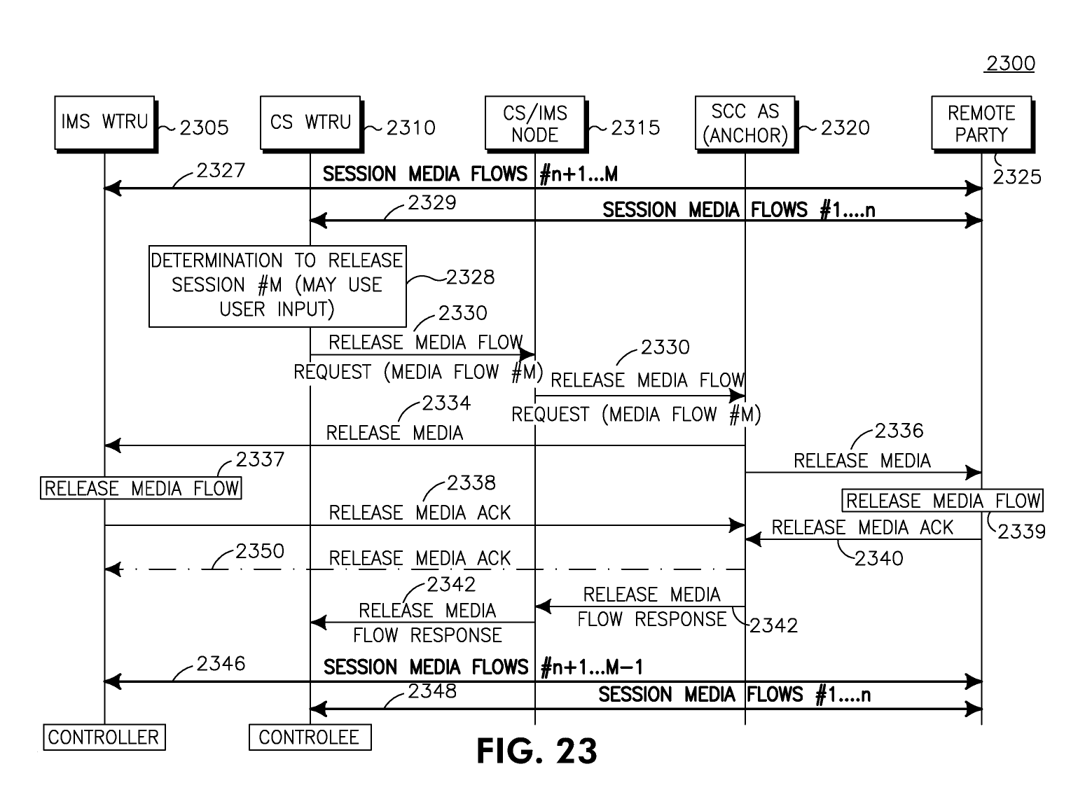

FIG. 23 shows an example of a media flow release within a collaborative IMS session 2300 between a IMS-capable WTRU 2305 and a CS WTRU 2310, where the SCC AS 2320 is an anchor for the session release initiated by the CS WTRU 2310 on the IMS-capable WTRU 2305. In this example the IMS-capable WTRU 2305 is the controlee and the CS WTRU 2310 is the controller.

For the purpose of media flow release within a collaborative session between the IMS-capable WTRU 2305 and the CS WTRU 2310, the CS WTRU 2310 appears as a IMS WTRU through the use of an intermediary, the CS IMS Node 2315. The CS IMS Node 2315 may be in communication with the CS WTRU 2310. The CS IMS Node 2315 performs a translation of PS domain messages prior to transmission of the messages to the CS WTRU 2310 and the CS IMS Node 2315 performs a translation of CS domain messages prior to transmission of the messages in the PS domain.

A CS WTRU 2310, controller, decides to release media flow 2328 within a collaborative session with an IMS-capable WTRU 2305, controlee. Prior to initiating the release, the IMS-capable WTRU 2305, CS WTRU 2310, the SCC AS 2320 and the Remote Party 2325 may establish one or more media flows 2327, 2329.

The CS WTRU 2310 may decide to release an IMS session 2338 with the IMS-capable WTRU 2305. This determination may be based on one or more preconfigured parameters and/or input from a user. The CS WTRU 2310 may send a release media request message 2330 including a media flow indicator to the SCC AS 2320, the anchor for the release, via the CS IMS Node 2315. The SCC AS 2320 may send a release media message 2336 to the Remote Party 2325 and a release media message 2334 to the IMS-capable WTRU 2305. Once the media is released 2337, 2339 the Remote Party 2325 sends a release media ACK 2340 and the IMS-capable WTRU 2305 sends a release media ACK 2338 to the SCC AS 2320. The SCC AS 2320 sends a media flow response 2342 to the CS WTRU 2310 via the CS IMS Node 2315. The IMS-capable WTRU 2305 and the CS WTRU 2310 continue with the collaborative session with the remaining media flows 2346, 2348.

In an alternative embodiment to FIG. 23, after the media is released 2337, 2339 and the Remote Party 2325 and the IMS-capable WTRU 2305 send a release media ACK 2338, 2340, respectively, to the SCC AS 2320, the SCC AS 2320 sends a release media ACK 2350 to the IMS-capable WTRU 2305.

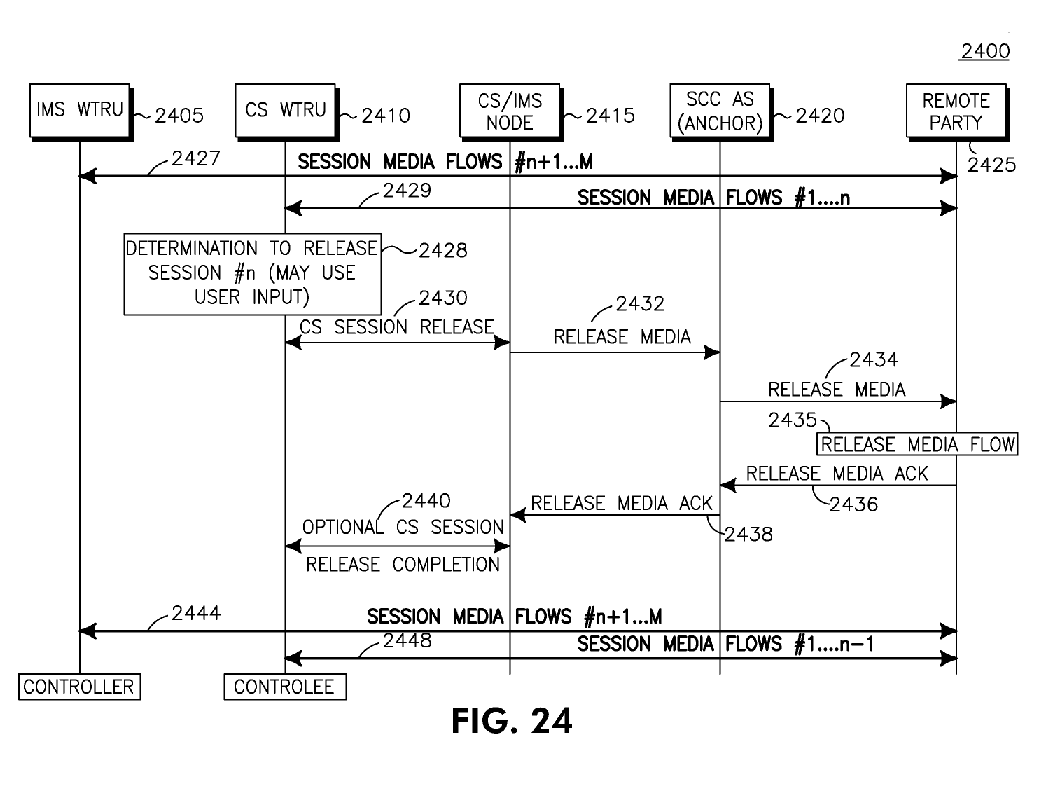

FIG. 24 shows an example of a media flow release within a collaborative IMS session 2400 between a IMS-capable WTRU 2404 and a CS WTRU 2410, where the SCC AS 2420 is an anchor for the session release initiated by the CS WTRU 2410 on itself. In this example the IMS-capable WTRU 2405 is the controlee and the CS WTRU 2410 is the controller.

For the purpose of media flow release within a collaborative session between the IMS-capable WTRU 2405 and the CS WTRU 2410, the CS WTRU 2410 appears as a IMS WTRU through the use of an intermediary, the CS IMS Node 2415. The CS IMS Node 2415 may be in communication with the CS WTRU 2410. The CS IMS Node 2415 performs a translation of PS domain messages prior to transmission of the messages to the CS WTRU 2410 and the CS IMS Node 2410 performs a translation of CS domain messages prior to transmission of the messages in the PS domain.

A CS WTRU 2410, controller, decides to release media flow 2428 within a collaborative session with an IMS-capable WTRU 2405, controlee. Prior to initiating the release, the IMS-capable WTRU 2405, CS WTRU 2410, the SCC AS 2420 and the Remote Party 2425 may establish one or more media flows 2427, 2429.

The CS WTRU 2410 may decide to release an IMS session 2428 on itself. This determination may be based on one or more preconfigured parameters and/or input from a user. The CS WTRU 2410 may exchange one or more CS session release messages 2430 with the CS IMS Node 2415. The CS IMS Node 2415 may send a release media message 2432 to the SCC AS 2420, the anchor for the release. The SCC AS 2420 may send a release media message 2434 to the Remote Party 2425. Once the media is released 2435 the Remote Party 2425 sends a release media ACK 2436 to the SCC AS 2420. The SCC AS 2420 sends release media ACK 2438 to the CS WTRU 2410 via the CS IMS Node 2415. The CS WTRU 2410 may exchange one or more CS Session Release Completion messages 2440 with the CS IMS Node 2415. The IMS-capable WTRU 2405 and the CS WTRU 2410 continue with the collaborative session with the remaining media flows 2444, 2448.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. An circuit switched (CS) IP Multimedia (IM) Subsystem (IMS) Node, the CS IMS Node comprising:
a receiver configured to receive a inter user equipment transfer (IUT) request from a source device to establish a collaborative session between a circuit switched (CS) wireless transmit/receive (WTRU) and a IMS WTRU;
a processor configured to process the IUT request; and
a transmitter configured to transmit the IUT request to a target device.

2. The CS IMS Node of claim 1 wherein the receiver is further configured to receive the IUT request from the IMS-capable WTRU.

3. The CS IMS Node of claim 1 wherein the receiver is further configured to receive the IUT request from the CS WTRU.

4. The CS IMS Node of claim 1 wherein the transmitter is further configured to transmit the IUT request via CS protocol signals to the CS WTRU.

5. The CS IMS Node of claim 1 wherein the transmitter is further configured to transmit the IUT request via PS protocol signals to the IMS-capable WTRU.

6. The CS IMS Node of claim 1 wherein the initiator of the IUT request is a controller.

7. The CS IMS Node of claim 1 wherein the non-initiator of the IUT request is a controlee.

8. The CS IMS Node of claim 1 wherein either a controller or a controlee initiates release of an IMS session.

9. The CS IMS Node of claim 1 further configured to connect the CS WTRU to IMS.

10. The CS IMS Node of claim 1 wherein the transmitter is further configured to transmit either the IUT request or an IUT response to a SCC AS.

11. A method for Inter-User Equipment Transfer (IUT) of an IP Multimedia (IM) Subsystem (IMS) session using a CS IMS Node, the method comprising;
receiving from a source device an IUT request to establish a collaborative session between a circuit switched (CS) wireless transmit/receive (WTRU) and a IMS-capable WTRU;
transmitting an IUT request to a target device;
receiving a response from the target device; and
transferring media to the target device.

12. The method of claim 11 wherein the target device is in another operator domain.

13. The method of claim 11 wherein the source device is a CS WTRU and the target device is an IMS-capable WTRU.

14. The method of claim 11 wherein the source device is a IMS-capable WTRU and the target device is a CS WTRU.

15. The method of claim 11 wherein a Service Centralization and Continuity Application Server (SCC AS) anchors IMS sessions and manages an access leg and a remote leg of the IMS sessions.

16. The method of claim 15 wherein the anchor SCC AS is located in either a source operator domain or a target operator domain.

17. The method of claim 11 wherein the IUT request/response is transmitted via CS protocol signals to the CS WTRU and via PS protocol signals to the IMS-capable WTRU.

18. The method of claim 11 wherein an initiator of the IUT request is a controller and a non-initiator of the IUT request is a controlee.

19. The method of claim 11 wherein either the controller or the controlee initiates release of an IMS session.

20. The method of claim 11 wherein the IMS Node connects the CS WTRU to IMS.
